(19) United States
(12) Patent Application Publication
(10) Pub. No.: US 2022/0086175 A1
(43) Pub. Date: Mar. 17, 2022

(54) METHODS, APPARATUS AND SYSTEMS FOR BUILDING AND/OR IMPLEMENTING DETECTION SYSTEMS USING ARTIFICIAL INTELLIGENCE

(71) Applicant: Ribbon Communications Operating Company, Inc., Westford, MA (US)

(72) Inventors: Shaun Jaikarran Bharrat, Edison, NJ (US); Charles W. Boyle, III, Upton, MA (US)

(21) Appl. No.: 17/460,195

(22) Filed: Aug. 28, 2021

Related U.S. Application Data
(60) Provisional application No. 63/079,298, filed on Sep. 16, 2020.

(51) Int. Cl. H04L 29/06; G06N 3/08; G06N 3/04

(52) U.S. Cl. CPC H04L 63/1416; G06N 3/0454; G06N 3/088

(57) ABSTRACT

Methods and apparatus for implementing and operating malicious transaction detection systems. An exemplary method embodiment includes the steps of: (i) operating, a malicious transaction detection system, to receive communications session establishment data; operating, the malicious transaction detection system, to determine a probability of whether or not the communications session establishment data indicates that the communications session is malicious; and when the determined probability is greater than or equal to a predetermined threshold value determining that a transaction corresponding to the received communications session establishment data is malicious; and when the determined probability is less than the predetermined threshold value determining that the transaction corresponding to the received communications session establishment data is not malicious; and wherein the malicious transaction detection system includes a determination model trained using synthetic communications session data.

### RELATED APPLICATIONS

The present application claims the benefit of U.S. Provisional Patent Application Ser. No. 63/079,298 which was filed on Sep. 16, 2020 and which is hereby expressly incorporated by reference in its entirety.

### FIELD OF INVENTION

The present invention relates to methods, systems, and apparatus for building and/or implementing detection systems using artificial intelligence, e.g., neural networks and machine learning models. The present invention also relates to detecting and/or mitigating service attacks using detection systems built and/or trained using artificial intelligence systems, e.g., neural networks and machine learning models, trained using synthetic data as opposed to actual customer data. The present invention further relates to methods, systems, and apparatus for detecting and/or determining fraudulent or malicious communications sessions, e.g., calls, and/or the probability that a communications session, e.g., a call, is fraudulent or malicious. The present invention further relates to methods, systems, and apparatus for generating models that can be used to identify and/or determine the probability that a communications session, e.g., a call, is fraudulent based on communications session, e.g., call, traffic characteristics and patterns. The present invention also relates to methods, systems, and apparatus for taking actions to mitigate, reduce and/or eliminate the harm that can be caused by communications sessions, e.g., calls, identified as potentially fraudulent, suspicious, and/or malicious. The present invention also relates to methods, systems, and apparatus for detecting and/or determining service attacks, e.g., denial of service attacks, and/or mitigating harm that may be caused by service attacks. The present invention also relates to methods, apparatus, and systems for generating and/or combining synthetic training data from one or more proprietary training data sets wherein the generated synthetic training data does not include proprietary information.

### BACKGROUND

Fraud is a common problem faced by communications network operators and carriers. As a result, there is a need for determining the probability that a call is related to a fraudulent scheme or being sent of malicious purposes.

Furthermore, various telephony use cases have a need to classify calls in various dimensions of fraud probability. For example, the carrier might use the probability that a call is fraudulent to determine whether the customer should be alerted to the possibility or even whether to block the call completely. As such, a trained detection system or classification model is needed, and a customer-specific model or detection system can be trained using that customer's data. Unfortunately, high-precision models and/or systems in this application generally require classification models and/or detection systems across many customers as fraudsters calls are usually spread across many customers. Building such classification models and/or detection systems requires data from many customers and, hence, can only be done using subsets of data that customers are willing to share outside their premises. Much of this data is considered either proprietary or personally-identifiable information (PII). This subsetting of the feature space results in subpar performance compared to what could be achieved with full data across multiple customers. The same problem exists for detecting and/or classifying service attacks, e.g., Denial of Service (DOS) attacks, based on service requests as the service request customer data similarly to the call data contains proprietary information.

From the foregoing it is apparent that there is a need for a technological solution as to how to mitigate the problem of needing to choose between a wide range of data (data from multiple customers) and a wide feature space (detailed features, including proprietary features) in building general classification models and/or detection systems for telephony fraud classification and/or service attack classification.

### SUMMARY OF THE INVENTION

The present invention provides a technological solution to the issues and problems with how to mitigate the problem of needing to choose between a wide range of data (data from multiple customers) and a wide feature space (detailed features, including proprietary features) in building general classification models and/or detection systems for telephony fraud classification and/or service attack classification. Various embodiments of the present invention include novel methods and apparatus to solve one or more of the problems identified above.

An exemplary method for detecting malicious (e.g., fraudulent, destructive, robocall and/or nuisance) transactions in accordance with one embodiment of the present invention includes the steps of: operating a malicious (e.g., fraudulent, destructive, robocall and/or nuisance) transaction detection system to receive communications session establishment data (e.g., session setup information such as for example source address information, destination address information, routing information, calling party identification information, called party identification information, etc.); operating the malicious transaction detection system to determine a probability of whether the communications session establishment data indicates that the communications session is malicious (e.g., fraudulent, destructive, robocall and/or nuisance transaction); and when the determined probability is greater than or equal to a predetermined threshold value determining that a transaction corresponding to the received communications session establishment data is malicious; and when the determined probability is less than the predetermined threshold value determining that the transaction corresponding to the received communications session establishment data is not malicious; and wherein the malicious transaction detection system includes a determination model (e.g., classifier model) trained using synthetic communications session data.

In some embodiments, the method further includes the step of: completing or directing a communications device to complete the communications session establishment in a standard manner when the transaction corresponding to the received communications session establishment data is determined to not be malicious.

In some embodiments, the method further includes the steps of: taking at least one mitigation action or directing a communications device to take at least one mitigation action when the transaction corresponding to the received communications session establishment data is determined to be malicious.

In some embodiments, the method further includes the step of: determining the mitigation action to be taken based on the probability determined that the transaction is malicious. In some embodiments, the step of taking at least one mitigation action includes taking one or more of the following actions: i) completing the establishment of the communications session corresponding to the communications session establishment data to a destination party or a destination device (e.g., a user equipment device) identified (e.g., via a destination address, called party ID, called party number) in the communications session establishment data with an indication that the communications session is suspected of being malicious; ii) redirecting the communications session corresponding to the communications session establishment data to a validation service; iii) assigning the communications session corresponding to the communications session establishment data a lower incoming communications session (e.g., call) priority than a non-suspect malicious communications session when placing the communications session (e.g., call) in a communication session (e.g., call) handling queue (thereby resulting in suspect malicious communications sessions having a longer delay before being answered on average than non-suspect malicious communications sessions); iv) delivering the communications session (e.g., call) corresponding to the communications session establishment data to voice mail; or v) dropping or blocking the communications session (e.g., call) corresponding to the communications session establishment data.

In some embodiments, the determination model is built, generated, created, and/or implemented using artificial intelligence machine learning.

In some embodiments, the synthetic communications session data is generated by a plurality of synthetic data generator neural networks. In some embodiments, the one or more of the plurality of synthetic data generator neural networks is trained using proprietary and/or confidential customer data.

In various embodiments, the synthetic communications session data does not include actual customer data. In some embodiments, the synthetic communications session data does not include any customer identifiable information. In various embodiments, the synthetic communications session data includes the characteristics and patterns of a plurality of different customers' actual proprietary, confidential and/or restricted customer data.

In some embodiments, the synthetic communications session data is generated by a plurality of synthetic data generator neural networks. In some such embodiments, the one or more of the plurality of synthetic data generator neural networks that is trained using actual proprietary or confidential customer data includes at least two synthetic data generator neural networks.

In some embodiments, the one or more of the plurality of synthetic data generator neural networks are built, created or generated using an adversarial training process. In some such embodiments, the adversarial training process may be, and often is, implemented at a customer's premises where said proprietary and/or confidential customer data is located and/or maintained.

In various embodiments, the adversarial training process utilizes a Generative Adversarial Network.

In at least some embodiments, one or more of the plurality of synthetic data generator neural networks is trained at a customer's premises using proprietary and/or confidential customer data maintained or located at the customer's premises.

In some embodiments, each of the synthetic data generator neural networks after being trained are re-located to a cloud environment, said cloud environment not being controlled or secured by the customer or customers on whose actual data the synthetic data generator neural network was trained.

In some embodiments, each of the one or more of the plurality of synthetic data generator neural networks is trained at a different customer premises using a different set of customer data.

In some embodiments, each of the synthetic data generator neural networks after being trained are re-located to a cloud environment. In some embodiments, the cloud environment is not controlled or secured by the customers whose customer data was used for training the synthetic data generator neural networks.

In various embodiments, one or more of the synthetic data generator neural networks is a variational autoencoder neural network.

In some embodiments, the method further includes the step of: generating said synthetic communications session data used for training the malicious transaction detection system using a plurality of synthetic data generator neural networks, said plurality of synthetic data generator neural networks each being trained using separate proprietary session transaction data sets obtained from customer session transaction records (e.g., CDRs).

In some embodiments, the method further includes the step of: prior to generating said synthetic communications session data, training a first synthetic data generator neural network to generate synthetic communications session data, said first synthetic data generator neural network being one of said plurality of synthetic data generator neural networks.

In various embodiments, the first synthetic data generator neural network is an autoencoder neural network. In some embodiments, the step of training the first synthetic data generator neural network includes the following operations and/or sub-steps: generating, by a labeling classifier, a training set of labeled input feature vectors based on actual customer communications session data (e.g., proprietary call detail records); inputting a first portion of the training set of labeled input feature vectors into the first synthetic data generator neural network; inputting noise (e.g., Gaussian noise) into one or more internal nodes (e.g., nodes of the encoder, bottleneck or decoder layers) of the synthetic data generator neural network; outputting from the first synthetic data generator neural network a set of synthetic data feature vectors; combining the outputted set of synthetic data feature vectors with a second portion of the training set of labeled input feature vectors; inputting the combined outputted set of synthetic data feature vectors and second portion of the training set of labeled input feature vectors to a discriminator classifier; making a determination by the discriminator classifier as to whether each inputted feature vector is a synthetic data feature vector; adjusting the link weights of the first synthetic data generator neural network based on feedback from the discriminator classifier.

In some embodiments, the step of training the first synthetic data generator neural network further includes the following operations and/or sub-steps: determining a classification error by the discriminator classifier as to whether the discriminator classifier incorrectly determined or classified an inputted feature vector as a synthetic data feature vector; adjusting link weights of the discriminator classifier to minimize the classification error; and wherein said adjusting the link weights of the first synthetic data generator neural network based on feedback from the discriminator classifier includes adjusting the link weights to maximize the classification error of the discriminator classifier.

In various embodiments, the step of training of the first synthetic data generator neural network continues until the classification error of the discriminator is above a first classification threshold value. In some embodiments, the first classification threshold value is 0.5 indicating that the discriminator classifier properly determines the classification of an input feature vector 50% of the time. In some embodiments, the first classification threshold is value 0.49 indicating that the discriminator classifier properly determines the classification of an input feature vector 51% of the time. In some embodiments the first classification threshold value is 0.40 indicating that the discriminator classifier properly determines the classification of an input feature vector 60% of the time. In some embodiments, the training of the first synthetic data generator neural network continues until the classification error of the discriminator is above the first classification threshold value for a first threshold number of synthetic data sample sets generated by the first synthetic data generator neural network. In some of the embodiments, the first threshold number of synthetic data sample sets must be consecutively generated by the first synthetic data generator neural network.

In various embodiments, the step of training of the first synthetic data generator neural network continues until the classification error of the discriminator is within a first classification threshold range for a threshold number of synthetic data sample sets generated by the first synthetic data generator neural network. In some of the embodiments, the threshold number of synthetic data sample sets must be consecutively generated by the first synthetic data generator neural network. In some embodiments, the first classification threshold range includes a first classification threshold range value and a second threshold classification range value. In some such embodiments the first classification threshold range value is 0.40 which indicates that the discriminator classifier properly determines the classification of an input feature vector 60% of the time and the second threshold classification range value is 0.45 which indicates that the discriminator classifier properly determines the classification of an input feature vector 55% of the time. In another embodiment, the first classification threshold range value is 0.39 and the second classification threshold range value is 0.44. In some embodiments, the first classification threshold range value is 0.40 and the second classification threshold range is 0.49. In various embodiments, the first classification threshold range includes the first and second classification threshold range values. In some other embodiments, the first classification threshold range excludes the first and second classification threshold range values. In some embodiments, the first classification error value of the discriminator is output to a file or display, and an operator determines when the training is complete such as, for example, when the outputted value is within a first classification threshold range for a period of time or for a number of sample sets.

In another exemplary method embodiment in accordance with the present invention is a method of generating synthetic data including the steps of: training a set of N synthetic data generator neural networks using N sets of actual customer data, each synthetic data generator neural network being trained using a different set of the N sets of actual customer data, one or more of the N sets of actual customer data including proprietary information, N being a positive integer number greater than 1; and upon completing the training of the N synthetic data generator neural networks, each synthetic data generator neural network is able to generate a synthetic data set of labeled (e.g., good and bad) data samples representative of an environment in which the synthetic data generator neural network is trained, the generated synthetic data set not including any of the proprietary information of the training data set.

In some embodiments, each of the synthetic data generator neural networks, which is trained using actual customer data including proprietary information, is trained in a controlled environment (e.g., at a secure location, e.g., customer premises, where the actual customer data is stored or maintained); and the synthetic data generated by each of the synthetic data generator neural networks, which is trained using actual customer data including proprietary information, includes data samples which are representative of the controlled environment in which the synthetic data generator was trained.

The present invention is also applicable to systems, devices and apparatus, for example, systems, devices, and apparatus which implement one or more steps of the invention described herein. The system(s), device(s), and apparatus may, and in some embodiments do, include one or more processors and a memory or storage device, the memory or storage device including instructions, e.g., software instructions, which when executed by the one or more processors control the system(s), device(s) or apparatus to perform one or more steps or operations of the methods described herein. In various embodiments, the systems, devices and apparatus are or include artificial intelligence systems, devices, and apparatus such as, for example, neural networks, autoencoders, artificial intelligence discriminators, and artificial intelligence classifiers.

An exemplary system in accordance with an embodiment of the present invention includes a malicious (e.g., fraudulent, destructive, robocall and/or nuisance) transaction detection device which includes memory; and a first processor, the first processor controlling the malicious transaction detection device to perform the following operations: receive communications session establishment data (e.g., session setup information such as for example source address information, destination address information, routing information, calling party identification information, called party identification information, etc.); determine a probability of whether the communications session establishment data indicates that the communications session is malicious (e.g., fraudulent, destructive, robocall and/or nuisance transaction); and when the determined probability is greater than or equal to a predetermined threshold value determining that a transaction corresponding to the received communications session establishment data is malicious; and when the determined probability is less than the predetermined threshold value determining that the transaction corresponding to the received communications session establishment data is not malicious; and wherein the malicious transaction detection device further includes a determination model (e.g., classifier model) trained using synthetic communications session data to classify communications session establishment data as good or bad.

In some embodiments, the first processor further controls the malicious transaction detection device to perform the following operation: complete or direct a communications device to complete the communications session establishment in a standard manner when the transaction corresponding to the received communications session establishment data is determined to not be malicious.

In some embodiments, the first processor further controls the malicious transaction detection device to perform the following operation: take at least one mitigation action or direct a communications device to take a mitigation action when the transaction corresponding to the received communications session establishment data is determined to be malicious.

In some embodiments, the first processor further controls the malicious transaction detection device to perform the following operation: determine the mitigation action to be taken based on the probability determined that the transaction is malicious.

In some embodiments, the operation of taking at least one mitigation action includes taking one or more of the following actions: i) completing the establishment of the communications session corresponding to the communications session establishment data to a destination party or a destination device (e.g., a user equipment device) identified (e.g., via a destination address, calling party ID, calling party number) in the communications session establishment data with an indication that the communications session is suspected of being malicious; ii) redirecting the communications session corresponding to the communications session establishment data to a validation service; iii) assigning the communications session corresponding to the communications session establishment data a lower incoming communications session (e.g., call) priority than a non-suspect malicious communications session when placing the communications session (e.g., call) in a communication session (e.g., call) handling queue (thereby resulting in suspect malicious communications sessions having a longer delay before being answered on average than non-suspect malicious communications sessions); iv) delivering the communications session (e.g., call) corresponding to the communications session establishment data to voice mail; or v) dropping or blocking the communications session (e.g., call) corresponding to the communications session establishment data.

In various embodiments, the determination model is built, generated, created, or implemented using artificial intelligence machine learning.

In some embodiments, the system further includes: a plurality of synthetic data generator neural networks. In various embodiments, the synthetic communications session data is generated by the plurality of synthetic data generator neural networks. In some embodiments, one or more of the plurality of synthetic data generator neural networks is trained using proprietary and/or confidential customer data. In most embodiments, the synthetic communications session data does not include actual customer data. In various embodiments, the synthetic communications session data does not include any customer identifiable information. In some embodiments, the synthetic communications session data includes the characteristics and patterns of a plurality of different customers' actual proprietary, confidential and/or restricted customer data.

In some embodiments, the synthetic communications session data is generated by a plurality of synthetic data generator neural networks; and the one or more of the plurality of synthetic data generator neural networks that is trained using actual proprietary or confidential customer data includes at least two synthetic data generator neural networks.

In some embodiments, the one or more of the plurality of synthetic data generator neural networks are built, created or generated using an adversarial training process; and the adversarial training process is implemented at a customer's premises where said proprietary and/or confidential customer data is located and/or maintained. In various embodiments, the adversarial training process utilizes a Generative Adversarial Network.

In some embodiments, the at least one of the plurality of synthetic data generator neural networks is trained at a customer's premises; and the proprietary and/or confidential customer data used to train the at least one of the plurality of synthetic data generator neural networks is maintained or located at the customer's premises.

Another exemplary system embodiment in accordance with the present invention includes: a set of N synthetic data generator neural networks trained using N sets of actual customer data, each synthetic data generator neural network being trained using a different set of the N sets of actual customer data, one or more of the N sets of actual customer data including proprietary information, N being a positive integer number greater than 1. Each of the synthetic data generator neural network upon completing its training is able to generate a synthetic data set of labeled (e.g., good and bad) data samples representative of an environment in which the synthetic data generator neural network is trained, the generated synthetic data set not including any of the proprietary information of the training data set.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates an exemplary system in accordance with an embodiment of the present invention.

FIG. 2 illustrates an autoencoder neural network.

FIG. 3 illustrates an exemplary computing device/node in accordance with an embodiment of the present invention.

FIG. 4 illustrates an exemplary assembly of components in accordance with an embodiment of the present invention.

FIG. 5 illustrates an exemplary method in accordance with an embodiment of the present invention.

FIG. 6 comprises FIGS. 6A and 6B.

FIG. 6A illustrates a first part of an exemplary method in accordance with an embodiment of the present invention.

FIG. 6B illustrates a second part of an exemplary method in accordance with an embodiment of the present invention.

FIG. 7 comprises FIGS. 7A, 7B, 7C, and 7D.

FIG. 7A illustrates a first part of an exemplary method in accordance with an embodiment of the present invention.

FIG. 7B illustrates a second part of an exemplary method in accordance with an embodiment of the present invention.

FIG. 7C illustrates a third part of an exemplary method in accordance with an embodiment of the present invention.

FIG. 7D illustrates a fourth part of an exemplary method in accordance with an embodiment of the present invention.

FIG. 8 comprises FIGS. 8A and 8B.

FIG. 8A illustrates a first part of an exemplary method in accordance with an embodiment of the present invention.

FIG. 8B illustrates a second part of an exemplary method in accordance with an embodiment of the present invention.

### DETAILED DESCRIPTION

Building and using general classification models and/or detection systems follows the standard machine-learning pipeline: a training set comprising prior data along with the actual label is used to train a model; then the model is validated using additional data which was not used in the model building; finally, the model is used for inference against new data (with unknown labels). The salient point is that the training uses “real” data. This is problematic for certain use cases because there might be trade or legal restrictions on providing this real data off the carrier's or customer's premises. In the present example, the data represents phone calls between individuals and hence there are privacy and legal issues restricting how and who may access and/or utilize the data and for what purposes the data may be accessed and/or utilized. The data includes information about calls being received and/or, in some embodiments, calls being placed. The data typically includes and/or is derived from call detail records (CDRs) that provide details and/or information about calls received and/or placed.

Various embodiments of the invention facilitate the building of classification models and/or detection systems when actual training data is available in (separate) controlled environments but not available in a global uncontrolled model building environment. At a very high level, the approach utilized is as follows. First, the actual training data is used in controlled environment C1 to build a generator G1 of labeled (good and bad) calls for that environment. This process is repeated in additional controlled environments C2, C3 to build generators G2, G3. The set of generators G1, G2, and G3 are then used in the global uncontrolled environment to generate a combined synthetic data set of labelled data containing samples representative of the controlled environments C1, C2, and C3. This synthetic data set is then used in a traditional machine-learning pipeline to build a global classification model that optimizes across the combined controlled environments C1, C2, and C3 (rather than to any specific environment). This model can then be used in either the global uncontrolled environment or within any of the controlled environments to classify future transactions.

The ability to achieve good results with this approach is heavily dependent on the quality of the synthetic data produced by a generator relative to an associated environment. Consequently, one of the focuses of this invention is on the generator portion of the solution which will be implemented using a Generative Adversarial Network (GAN).

In general, at the present time, Generative Adversarial Networks are machine learning models that typically utilize two neural networks—a generator neural network and a discriminator neural network. The discriminator neural network is sometimes referred to herein as a distinguisher. The random variables are input into the generator which generates new fake data samples. The generated fake data samples are combined with real data samples and inputted to the discriminator neural network. The discriminator neural network classifies each sample as real or fake. The generator and discriminator neural networks are trained together in an adversarial manner or competition. The generator neural network is trained to maximize the final classification error between the true samples and the generated fake samples while the discriminator neural network is trained to minimize the final classification error, the classification error being determined by a classification loss function, e.g., cross entropy loss function. At each iteration of the training process, the weights of the generative neural network are updated in order to increase the classification error while the weights of the discriminative neural network are updated to decrease the classification error. Once the adversarial training has been completed, the generator neural network is able to generate fake samples which are difficult to distinguish from real samples, i.e., the generator neural network is able to generate synthetic high quality data sets having characteristics and/or attributes similar to or which mimic the real data sets.

The steps of an exemplary method in accordance with an embodiment of the present invention will now be described using a Generative Adversarial Network.

1. Start with a data set of training data T. This data comprises a large number of calls along with the input features I associated with the call and the correct labeling L for the call.

2. Build a labeling classifier K_L using the training data T using standard machine-learning procedures. This classifier must predict the label L given the input features I. Standard machine learning procedures are discussed in the following two articles, both articles being herein incorporated by reference in their entirety:

(i) “7 Steps to Machine Learning: How to Prepare for an Automated Future,” dated May 23, 2019 by Dr. Mark van Rijmenam, https://medium.com/dataseries/7-steps-to-machine-learning-how-to-prepare-for-an-automated-future-78c7918cb35d; and

(ii) “The Seven Steps Of Machine Learning” dated Oct. 24, 2017 by Kirti Bakshi, https://www.techleer.com/articles/379-the-seven-steps-of-machine-learning.

3. Create an initial version G_0 of a generator. The Generator must create a sample of input variables intended to mimic samples in the training set T.

4. Use G_0 to generate a data batch B_0. Expand B_0 to include the associated labels using labeling classifier K_L.

5. Create a new training set T_n by combining B_ n, in the first iteration B_n is B_0, with a number of samples from T with a target label distinguishing the real T samples from B_n samples. The number of samples will be based on or depend on the model and/or the number of model parameters. In one embodiment, the number of samples=10× number of model parameters. The number of model parameters in turn depends on the type and size of the model. For example, in a model that has 10,000 parameters, 100,000 samples would be used. Additionally, typically the number of T_n and B_n samples used are approximately the same and/or are within a threshold so that the number of actual samples and synthetic samples in the data set are balanced. In some embodiments the threshold is expressed as a ratio of T_n samples to B_n sample. In one exemplary embodiment, a threshold of 1.5:1 is used. In some embodiments, up-sampling is used. In some other embodiments down-sampling is used.

6. Create a new classifier K_d using training data T_n. This classifier (the Distinguisher/Discriminator) must predict whether a sample is real (from T) or synthetic (from B).

7. Refine the generator G_n to create better synthetic data batch B_n. Expand B_n to include the associated labels using labeling classifier K_L.

8. Use classifier K_d to evaluate the generator G_n.

9. If accuracy of K_d is much greater than 0.5 (i.e. it is easy to distinguish or discriminate real samples from synthetic samples), repeat from step #7.

10. When accuracy of K_d drops to about 0.5, start over at Step #5 (i.e. refine the Distinguisher/Discriminator) until enough overall cycles without improvement.

11. When the generator has been trained, use generator to provide/deliver a final generated synthetic data set. For example, the generator may be, and in some embodiments is, used in the controlled environment to generate the final synthetic data set which is then provided and/or delivered to a different environment outside the controlled environment for use in training/building detector(s) and/or classifier(s). In some other embodiments, the trained generator is re-located from the controlled environment to a different environment outside the controlled environment where the generator is then used to generate synthetic data for use in training/building detector(s) and/or classifier(s). In some embodiments, a combination of the generated synthetic data and the trained generator are re-located from the controlled environment to a different environment outside the controlled environment.

The rest of the method involves the design of the Generator. In one exemplary embodiment a variational autoencoder is used as the Generator. However, any Generator design that could be coupled with the Detector feedback can be applied here. The Generator is typically a neural network. In some embodiments an autoencoder neural network is used for the Generator. While in an exemplary embodiment the distinguisher/discriminator classifier is a neural network, other types of classifiers may be, and in some embodiments are, used for the distinguisher/discriminator classifier.

Training of the generator neural network may be, and in some embodiments is, implemented directly on a network element or device, on hand sets, or on probes collecting/measuring call transaction related information.

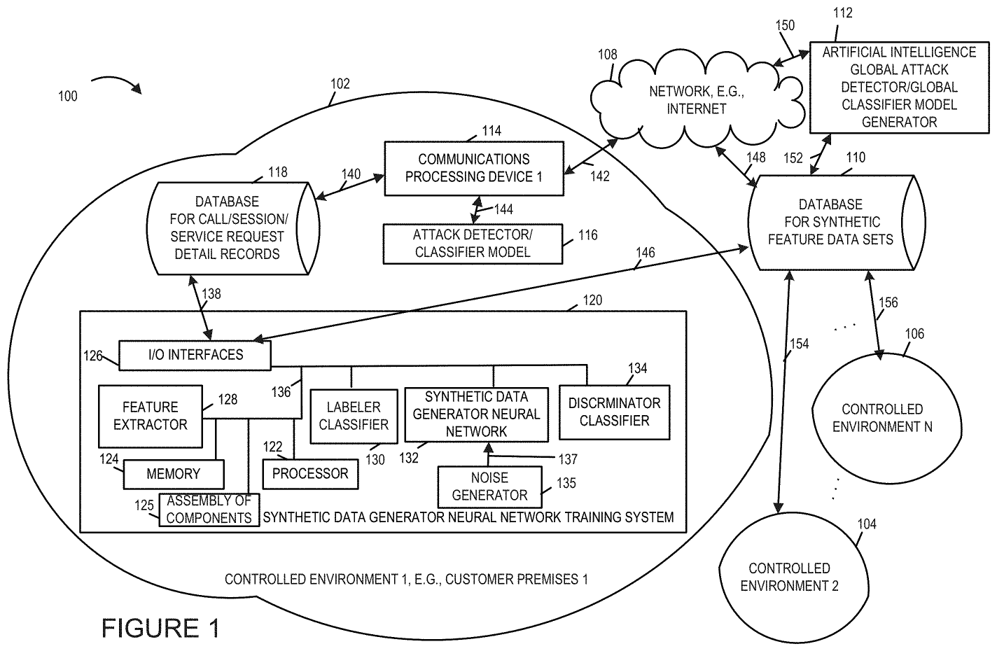

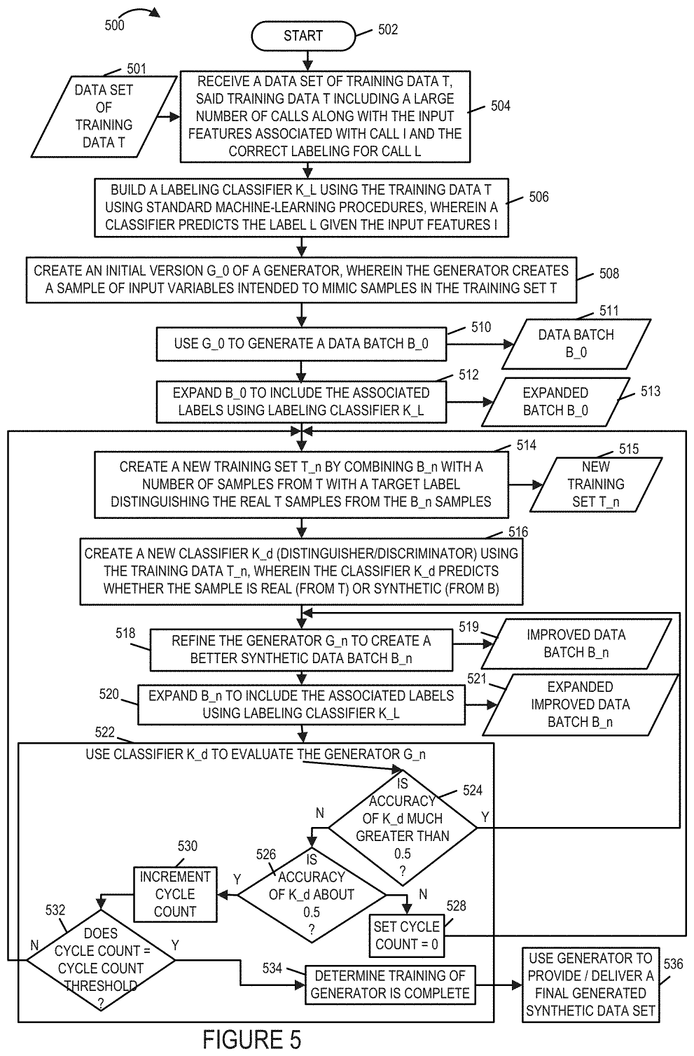

FIG. 5 is a flowchart 500 of an exemplary method in accordance with an exemplary embodiment. The exemplary method 500 may be implemented, and in some embodiments is implemented, using the exemplary system 100 illustrated in FIG. 1. However, it should be understood that the method may be implemented using other systems and other system configurations than those illustrated in FIG. 1. While it will be readily understood that additional steps and signaling are performed in connection with communicating information, data, messages, and signals between devices, the method 500 focuses on and discusses the steps and/or signaling for understanding the invention.

The exemplary method will be described using a Generative Adversarial Network. Operation starts in step 502 and proceeds to step 504. In step 504 a data set of training data T 501 is received. The data set of training data T 501 comprises a large number of calls along with the input features I associated with call and the correct labeling L for call. Operation proceeds from step 504 to step 506.

In step 506 a labeling classifier K_L is built using the training data T using standard machine-learning procedures, wherein a classifier K_L predicts the label L given the input features I. Operation proceeds from step 506 to step 508.

In step 508 an initial version G_0 of a generator is created, wherein the generator creates a sample of input variables intended to mimic samples in the training set T. Operation proceeds from step 508 to step 510.

In step 510 generator G_0 is used to generate a data batch B_0 511. Operation proceeds from step 510 to step 512. In step 512 data batch B_0 511 is expanded to include the associated labels using label classifier K_L. The result of step 512 is expanded batch B_0 513. Operation proceeds from step 512 to step 514.

In step 514, a new training set T_n 515 is created by combining B_n with a number of samples from T with a target label distinguishing the real T samples from the B_n samples. (In the first iteration of step 514, B_n is B_0.) The number of samples will be based on or depend on the model and/or the number of model parameters. In one embodiment, the number of samples=10×number of model parameters. For example, in a model that has 10,000 parameters, 100,000 samples would be used. Additionally, typically the number of T_n and B_n samples used are approximately the same and/or are within a threshold so that the number of actual samples and synthetic samples in the data set are balanced. In some embodiments, the threshold is expressed as a ratio of T_n samples to B_n samples. In one exemplary embodiment, a threshold of 1.5:1 is used. In some embodiments, up-sampling is used. In some other embodiments down-sampling is used.

Operation proceeds from step 514 to step 516. In step 516 a new classifier K_d (distinguisher/discriminator) is created using the training data T_n, where the classifier K_d predicts whether the sample is real (from T) or synthetic (from B). Operation proceeds from step 516 to step 518.

In step 518 the generator G_n is refined to create a better synthetic data batch B_n. The result of step 518 is improved data batch B_n 519. Operation proceeds from step 518 to step 520.

In step 520 B_n is expanded to include the associated labels using labeling classifier K_L. Expanded improved data batch B_n 521 is an output of step 520. Operation proceeds from step 520 to step 522.

In step 522 classifier K_d is used to evaluate the generator G_n. Step 522 includes steps 524, 526, 528, 530, 532, and 534. In step 524 a determination is made as to whether or not the accuracy of K_d is much greater than 0.5. If it is determined that the accuracy of K_d is much greater than 0.5 (i.e. it is easy to distinguish or discriminate real sample from synthetic samples), then operation proceeds from step 524, to the input of step 518, in which the generator is refined. However, if it is determined that the accuracy of K_d is not much greater than 0.5, then operation proceeds from step 524 to step 526. In some embodiments, a K_d value which is much greater than 0.5 is a K_d value of 0.8 or greater.

In step 526 a determination is made as to whether or not the accuracy of K_d is about 0.5. If it is determined that the accuracy of K_d is not about 0.5, then operation proceeds from step 526 to step 528, in which the counter cycle count is set equal to 0. Operation proceeds from step 528 to the input of step 514, in which a new training set is created. In some embodiments, a K_d which is about 0.5 is a K d value which is between 0.5 and 0.6.

However, if it is determined that the accuracy of K_d is about 0.5, then operation proceeds from step 526 to step 530. In step 530 cycle count is incremented. Operation proceeds from step 530 to step 532. In step 532, it is determined if the cycle count equals cycle count threshold. If the determination is that cycle count does not equal cycle count threshold, then operation proceeds from step 532 to the input of step 514, in which a new training set is created. In subsequent step 516, the Distinguisher/Discriminator will be refined. However, if the determination of step 532 is that the cycle count equals cycle count threshold, then operation proceeds from step 532 to step 534, in which a determination is made that the training of the generator is complete. Operation proceeds from step 534 to step 536.

In step 536 the generator is used to provide/deliver a final generated synthetic data set.

While the present exemplary embodiment discusses the building of fraud detection systems and/or classification models when actual training data is available in (separate) controlled environments but not available in a global uncontrolled model building environment, the methods, apparatus and systems described are also applicable for providing communications/data security services which for example provide for the monitoring, detection, prevention and/or mitigation against various types of attacks.

Exemplary Data Security Use Cases

Similar to voice fraud analysis and other call related use cases such as spam, this technique can be used for data application security scenarios. Exemplary security usage scenarios include:

1. Scanning attacks that are attempting to hack into open server ports or exploit system vulnerabilities.

2. Denial of service attacks where overloading of a system is attempted by another system. DDOS (Distributed DOS) would be similar but with multiple systems working in concert.

In these data security scenarios, various attack algorithms are implemented to exploit weaknesses to bring down, take over or otherwise compromise a system. Some attempts to address these data security scenarios have included the identification and/or determination of exploits by determining spikes in activity, determining a threat and adding information about the threat to a particular customer system, e.g., source of the threat, to a customer blacklist. The customer blacklists may be shared with others to produce a more comprehensive blacklist of potential sources of threats. With proxies, cloud compute, orchestration, and other network automation, it is not sufficient or optimal to create blacklists. The present invention may be used, and in some embodiments is used, for extracting details of application meta data (flow activity, application information, retry patterns, etc) which are then used to automatically characterize the different algorithms (rather than the servers they are deployed on).

Exemplary Marketing/Debugging Scenario

The present invention is also applicable to marketing and debugging scenarios including for example extracting behavioral classification models which are not traffic models but instead are usage patterns and relationships from a plurality of proprietary, confidential, or restricted customer data sets. This is achieved by using the actual data to generate, build or create synthetic data generators on a customer's premises so that the actual data remains secure. The synthetic data generators once trained on the actual data can then be used to generate synthetic data for each customer which does not include proprietary or confidential information of the customer but includes the usage patterns and relationship. The synthetic data from each of the synthetic data generators is combined, and the combined synthetic data provides training data which accurately simulates a plurality of different customers. The generated synthetic data can then be used to build, create, or generate behavioral classification models. Behavioral examples include: (i) building out models for different areas of world, and (ii) learning content usage to build out user segments.

Customer Data

The actual customer data, e.g., call data which is featurized and used in training the synthetic data generator neural network, may, and typically does, include proprietary information such as calling party numbers which are extracted from call data records, session detail records and/or service request detail records. When the call, session or request is being made using Session Initiation Protocol and/or Session Description Protocol, the extracted data from the call, session or request data which is featurized includes parameters from the SIP initiation request message and/or SDP offer messages with call, session or request origination information such as calling party source identification information including for example, identifying characteristics of the calling party and/or other source identifiers of a call/session/request such as for example a session origination address, an Internet Protocol address and port number, a Session Initiation Protocol (SIP) message origination address, source IP address and Session Initiation Protocol agent identifier, source identifier included in SIP contact header information, and source identifying information included in the first SIP VIA header. The calling party source identification information merely needs to identify a particular calling source and be determinable from an initial call request.

Additional exemplary parameters which may be, and in some embodiments are, used for featurization of call/session/service requests include media based parameters and SIP based parameters.

Media Based Parameters

Media characteristics such as for example jitter, latency, round-trip-time (RTT) may be, and in some embodiments are, used as parameters. These parameters would be mainly applicable for cases where a number of RTP streams are originating from the same location and/or network address such as for the cases where an RTP stream is originating from the fraud or service attack entity and is not terminated in-between, e.g., for transcoding.

Media statistics value ranges are assigned a numeric value, which is configurable in terms of number of ranges, range start and end values and the numeric value for each range. For example, with respect to latency the following values may be assigned:

Latency-1[10 ms-30 ms]=1

Latency-2[31 ms-50 ms]=2

Latency-3[51 ms-80 ms]=3

Latency-4[81 ms and above]=4

A “latency score” for the call is determined based on the measured latency value. For example, a measured latency value of 63 ms would correspond to “3”.

Each media metric value is then input into the machine learning algorithm as a parameter.

SIP Based Parameters

SIP based parameters to be inputted into the machine learning algorithm include:
Order of SIP headers/parameters in SIP message, e.g., SIP INVITE message;
The way SIP headers/parameters are formatted and their values in SIP messages, e.g., SIP INVITE message
The way SIP message bodies are formatted/their values, e.g., SIP INVITE message bodies and the SDP offer messages included therein.

The following is a list of exemplary SIP based parameters that may be, and in some embodiments are, inputted into the machine learning algorithm to generate the synthetic data generator model.

1. Is Tel-URI or SIP-URI used in From/To headers?

2. Is “user=phone” parameter used in From/To header?

3. Is “<>” used in Request-URI, To/From headers?

4. CSeq value used.

5. Is “port” used in Request-URI?

6. Whether Contact header is in IP Address or FQDN form?

7. Does Request-URI, Contact header have “transport” parameter?

8. Are “empty spaces” used between parameters in Request-URI, From/To/Contact headers? If so how many?

9. Whether Contact header has following feature-tags: audio, automata, class, duplex, data, control, mobility, description, events, priority, methods, schemes, application, video, language, type, is focus, actor, text, extensions.

10. Number of Route, Record-Route headers

11. Whether a single header with multiple values or multiple header instances are used if there are more than one Route/Record-Route headers.

12. Order of To/From/Contact/CSeq headers.

13. Which of the following option-tags are present in Supported/Require headers: 199, answermode, early-session, eventlist, explicitsub, from-change, geolocation-http, geolocation-sip, gin, gruu, histinfo, ice, join, multiple-refer, norefersub, nosub, outbound, path, policy, precondition, pref, privacy, recipient-list-invite, recipient-list-message, recipient-list-subscribe, record-aware, replaces, resource-priority, sdp-anat, sec-agree, siprec, tdialog, timer, uui.

14. Is P-Early-Media header present?

15. Is P-Asserted-Id header present?

16. Is PRACK/UPDATE used during session negotiation?

17. Whether c-line is used as a session or media attribute in SDP.

18. List of offered codecs and their order.

19. Dynamic payload values used for codecs.

20. Clockrates used for applicable codecs.

21 fmp values used for codecs.

22. Is ptime/maxptime used?

23. Is RS/RR bandwidth modifier used?

24. SDP o-line username, sess-id, sess-version formats.

25. Is SDP i-line used?

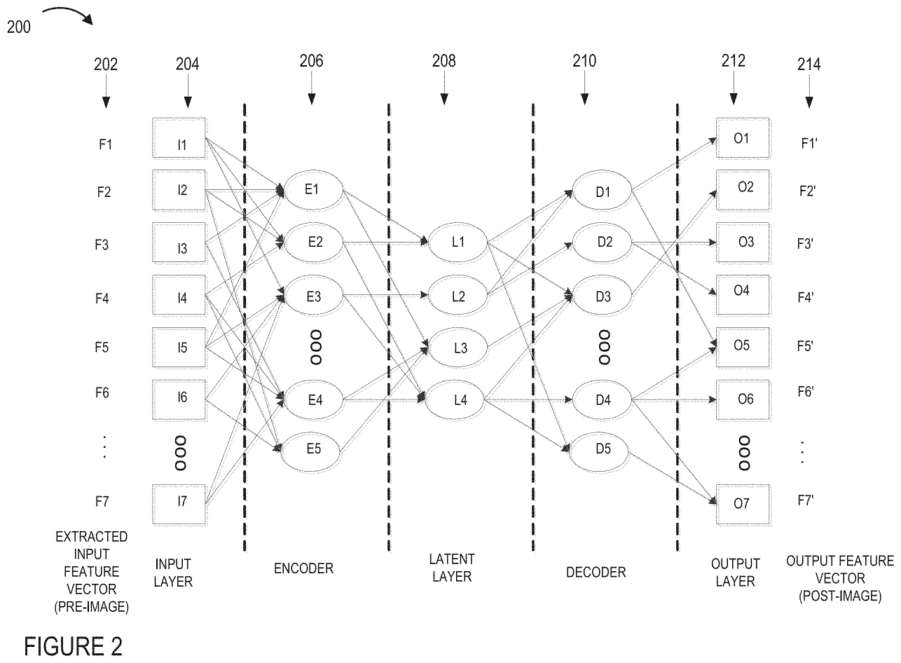

In some embodiments, the synthetic data generator neural network is an autoencoder neural network. FIG. 2 shows an exemplary autoencoder neural network. The synthetic data generator autoencoder neural network is trained using feature vectors. For example, the data of each call is featurized and a feature vector is created. The feature vector is input into the synthetic data generator autoencoder neural network and randomized noise, e.g., Gaussian noise, is input to one or more nodes in the latent or bottleneck layer of the synthetic data generator autoencoder neural network. The output vector generated by the synthetic data generator auto-encoder neural network will be a synthetic feature vector which is different from the actual input feature vector by the error introduced by the autoencoder plus the noise introduced to the one or more nodes in the latent or bottleneck layer.

FIG. 1 illustrates an exemplary system 100 in accordance with an embodiment of the present invention. The exemplary system 100 includes a plurality of controlled environments (controlled environment 1 102, controlled environment 2 104, . . . , controlled environment N 106, N being a positive integer greater than 2), a database for synthetic feature data sets 110, a network, e.g., the Internet, 108, an artificial intelligence global attack detector/global classifier model generator 112, and a plurality of communications links coupling and/or connecting the components of system 100 as shown in FIG. 1. The exemplary controlled environments 102, 104, . . . , 106 are typically secure locations such as for example a customer premises where proprietary information such as for example call/session/service request detail records may be maintained.

The exemplary controlled environment 102 includes communications processing device 1 114, attack detector/classifier model device 116, database for call/session/service request detail records 118, a synthetic data generator neural network training system 120, and a plurality of communications links 138, 140, 142, 144, 146 which couple and/or connect various elements of the controlled environment 102 to each other allowing for the exchange of information, data, and commands. The synthetic data generator neural network training system 120 includes a processor 122, memory 124, an assembly of components 125, e.g., hardware components, I/O Interfaces 126, a feature extractor 128, a labeler classifier 130, a synthetic data generator neural network 132, and a discriminator classifier 134 (e.g., discriminator classifier implemented using a Naive Bayes classifier and/or a neural network classifier such as a logistic regression classifier), a noise generator 135 (e.g., a Gaussian noise generator), communications link 136 which couples and/or connects the processor 122, the I/O Interfaces 126, feature extractor 128, memory 124, assembly of components 125, labeler 130, synthetic data generator neural network 132, and classifier 134 together and allows these components to exchange information, data and/or commands. The noise generator 136 is coupled to the synthetic data generator neural network 132 via communications link 137. In the exemplary system 100 each of the controlled environments—controlled environment 2 104, . . . , controlled environment N—include devices/systems/databases the same as or similar to controlled environment 1 102. Each of the controlled environments may be, and in some embodiments are, different customers, e.g., wherein the customers may be for example service providers, enterprise businesses, telephone network operators, etc. Controlled environment 2 104, . . . , Controlled environment N 106 are connected and/or coupled to the Database For Synthetic Feature Data Sets 110 via communications link 154, . . . communications link 156 respectively. The communications link 148 couples and/or connects the network 108, e.g., the Internet, to the Database For Synthetic Feature Data Sets 110. The communications link 150 couples and/or connects the artificial intelligence global attack detector/global classifier model generator 112 to the network 108. The communications link 152 couples and/or connects the Database For Synthetic Feature Data Sets 110 to the artificial intelligence global attack detector/global classifier model generator 112.

In some embodiments, the synthetic data generator neural network training system 120 is implemented as an apparatus or device. In some such embodiments, the synthetic data generator neural network 132 is extractable from the synthetic data generator neural network device so that it may be relocated and/or used separately from the synthetic data generator neural network training system 120.

The artificial intelligence global attack detector/global classifier model generator 112 is in an uncontrolled environment and generates a global attack detector/classifier model using synthetic data sets, e.g., synthetic feature data sets, generated by the synthetic data generator neural networks included in two or more of the controlled environments. The artificial intelligence global attack detector/global classifier model generator in some embodiments uses synthetic data from the controlled environments as training data to build, create or generate one or more global attack detector/global classifier models. The attack detector/classifier model 144 included in the controlled environment may be, and in some embodiments is, built or generated by the artificial intelligence global attack detector/global classifier model generator using synthetic feature data sets not only from controlled environment 1 but also from two or more of the controlled environments controlled environment 2, . . . , controlled environment N, the synthetic feature data sets being used to train the attack detector/classifier model 144. In some embodiments, a plurality of different attack detector/classifier models are generated by the artificial intelligence global attack detector/global classifier model generator 112 with one or more of the plurality of different global attack detector/classifier models trained for the detection/classification of a different type of attack, the different types of attacks including for example a denial of service attack such as a distributed denial of service attack, a calling fraud attack, or a robocall attack. In some embodiments, one or more different types of generated global attack detector/global classifier models are deployed to one or more controlled and/or uncontrolled environments.

In terms of the above described method, the training data set T is generated by communications processing device 1 114 which processes incoming requests (e.g., call initiation requests, session initiation requests, service requests) such as SIP Invite requests for calls received from the network 108. The training data set T includes call detail records. The training data set T is stored in database 118. The synthetic data generator neural network training system 120 receives the training data set T from database 118. Feature extractor 128 extracts features, e.g., a feature vector, from data, e.g., data corresponding to a call, from the training data set. The label classifier 130 may, and in some embodiments does, perform the steps and/or functions of the labeling classifier K_L described in the method embodiment above. The synthetic data generator neural network 132 and discriminator classifier 134 in some embodiments form a Generative Adversarial Network. The synthetic data generator neural network 132 may, and in some embodiments does, perform the steps and/or functions of the Generator described in the method embodiment above. The discriminator classifier 134 may, and in some embodiments does, perform the steps and/or functions of the K_d (Discriminator/Distinguisher Classifier) described in the method embodiment above. The noise generator 135 injects noise, e.g., random Gaussian noise, onto one or more internal nodes of the synthetic data generator neural network 132 as the synthetic data generator neural network 132 is being trained.

Upon the completion of the training of the synthetic data generator neural network 132, it produces a synthetic data set, e.g., a synthetic feature data set which mimics the actual data of the controlled environment 1 102. In some embodiments, the synthetic data set does not include any proprietary information, in some embodiments proprietary information being user or customer identifiable information. In some embodiments, the synthetic data set does not include confidential information. The produced synthetic data set is supplied, e.g., transmitted by the synthetic data generator neural network training system, to the database 110 which stores the synthetic data generated by each of the synthetic data generator neural network training systems in controlled environments 1, 2, . . . , N, the database 110 being located in an uncontrolled environment and/or outside of the controlled environments from which the synthetic data sets were generated. In some embodiments, after the synthetic data generator neural network is trained, it or a copy of it is re-located to a location outside of the controlled environments. For example, in some embodiments, the synthetic data generator neural networks from each of the controlled environments 1 102, 2 104, . . . , N 106 once trained become part of the artificial intelligence global attack detector/global classifier model generator and are used to produce synthetic data which simulates or mimics the actual data from the controlled environment in which the synthetic data generator neural network was trained. In some such embodiments, the data base for synthetic data 110 may not be used as the synthetic data generators from the controlled environments are available for generating synthetic data within the artificial intelligence global attack detector/global classifier model generator. In some other embodiments, the database 110 is used by the artificial intelligence global attack detector/global classifier model generator to store the synthetic data which it generates using the trained synthetic data generator neural networks from the controlled environments.

As previously described, the synthetic data generators from the controlled environments once trained on the actual data from their controlled environment are then used to generate synthetic data for each controlled environment which does not include proprietary or confidential information but includes the usage patterns and relationship. The synthetic data from each of the synthetic data generators is combined, and the combined synthetic data provides training data which accurately simulates a plurality of different controlled environments. This combined synthetic data set is then used in a traditional machine-learning pipeline in the artificial intelligence global attack detector/global classifier model generator to generate, create, and/or build a global attack detector and/or classification model that optimizes across the combined controlled environments which include controlled environments 1 102, 2 104, . . . , N 106 (rather than to any specific environment). This global attack detector/global classification model can then be used in either the global uncontrolled environment or within any of the controlled environments to classify future transactions.

The attack detector/classifier model 116 may be, and in some embodiments is, an attack detector/classifier model generated by the artificial intelligence global attack detector/global classifier generator 112 and deployed to the controlled environment 1 102, e.g., customer premises 1.

In some embodiments, instead of attack detectors and/or classifier models, behavioral classification models are generated for example to simulate content usage in different environments such as different parts of a geographical location, the simulations then being used in the generation of networks and/or infrastructure (content servers, switches, etc.) to support the simulated content usage.

In some embodiments, the synthetic data generator neural network 132 is implemented as an autoencoder neural network. FIG. 2 illustrates an exemplary autoencoder neural network 200.

An example architecture of an autoencoder neural network 200 is shown in FIG. 2. The left half of the neural network comprises the input layer 204 and encoder 206. The extracted input feature vector 202 includes F1, F2, F3, F4, F5, F6, . . . , F7. The input feature vector is also sometimes referred to as a pre-image. F1, F2, F3, F4, F5, F6, . . . , F7 are numerical values. The extracted input feature vector is inputted into the input layer 204 with F1, F2, F3, F4, F5, F6, . . . , F7 being inputted into I1, I2, I3, I4, I5, I6, . . . , I7 respectively. The pre-image, also referred to as the input feature vector, is fed through some number of hidden layers which constitute the encoder 206, that is the encoder may include one or more encoding layers. The output of the encoder 206 of autoencoder neural network 200 is captured by the latent layer 208. The right half of the autoencoder neural network 200 is the decoder 210. The decoder 210 reconstructs a “post-image” also referred to as an output vector which can be compared to the “pre-image” or input vector. The decoder outputs the post-image to the output layer 212. The decoder 210, similar to the encoder 206, may include one or more decoding layers. The output layer 212 outputs the output feature vector which is sometimes referred to as a post-image. The O1, O2, O3, O4, O5, O6, . . . , O7 outputs respectively F1′, F2′, F3′, F4′, F5′, F6′, . . . , F7′ of the output feature vector 214. The output feature vector are primes of the input feature vector because the post-image is not identical to the pre-image, that is, there is some error or loss of information during the encoding and decoding process. E1, E2, E3, . . . , E4, E5 of the encoder 206 are encoder neural network nodes. L1, L2, L3, L4 are latent layer neural network nodes of the latent layer 208. D1, D2, D3, . . . , D4, D5 are decoder neural network nodes of the decoder 210. O1, O2, O3, O4, O5, O6, . . . , O7 are output nodes of the output layer 212. Each of the arrows from the Input Layer nodes I1, I2, I3, I4, I5, I6, . . . , I7 204 to the Encoder nodes E1, E2, E3, . . . , E4, E5 are neural network links having weightings. Each of the arrows from the Encoder 206 neural network nodes E1, E2, E3, . . . , E4, E5 to the neural network latent layer 208 nodes L1, L2, L3, L4 are neural network links having weightings. Each of the arrows from the latent layer neural network nodes L1, L2, L3, L4 to the decoder 210 neural network nodes D1, D2, D3, . . . , D4, D5 are neural network links having weightings. Each of the arrows from the decoder 210 neural network nodes D1, D2, D3, . . . , D4, D5 to the output layer 212 neural network nodes O1, O2, O3, O5, O5, O6, . . . , O7 are neural network links having weightings. The value or weightings of the links are determined during the training of the autoencoder neural network. Autoencoder neural networks are often used on images and, hence, the input and output are often referred to using image terminology. The goal is to minimize some error between the original image (pre-image or input vector) and the reconstructed image (post-image or output vector).

When the synthetic data generator neural network 132 is implemented as an autoencoder, e.g., autoencoder 200, the noise generator 135 injects noise during training of the neural network into one or more nodes of the encoder, latent layer, also referred to as a bottleneck layer, or into one or more nodes of the decoder of the autoencoder. For example, the noise generator may, and in some embodiments does, inject Gaussian noise (e.g., in the form of numeric values) into the nodes L1, L2, L3 and L4 during the training of the synthetic data generator neural network 132. The injection of the noise increases the error introduced and will be reflected in output feature vector.

In some embodiments, the global attack detector/global classifier model generated by the artificial intelligence global attack detector/global classifier model generator is trained to detect malicious (e.g., fraudulent, destructive, robocall and/or nuisance) transactions and/or transactions which form or are part of an attack (e.g., fraudulent call attack, distributed denial of service attack, a robocall attack). In some embodiments, the generated or created global attack detector/global classifier model is a malicious transaction detection system. In some embodiments, the attack detector/classifier model 116 is a malicious transaction detection system generated by the artificial intelligence global attack detector/global classifier model generator trained using synthetic data which mimics a plurality of different controlled environments, e.g., customer environments. In some embodiments, the global attack detector/global classifier model generated by the global attack detector/global classifier model 112 is deployed as part of the communications processing device 1 114. In some such embodiments, the global attack detector/global classifier model is used to detect the likelihood or probability that an incoming request and/or transaction (e.g., call request, session request, service request) is or is part of one or more different types of attacks (e.g., fraud call attack, denial of service attack, robocall attack). In some embodiments, the communications processing device 1 114 and/or the attack detector/classifier model device 116 take a mitigation action in connection with a request and/or transaction determined to have a probability above a threshold that the transaction and/or request is an attack.

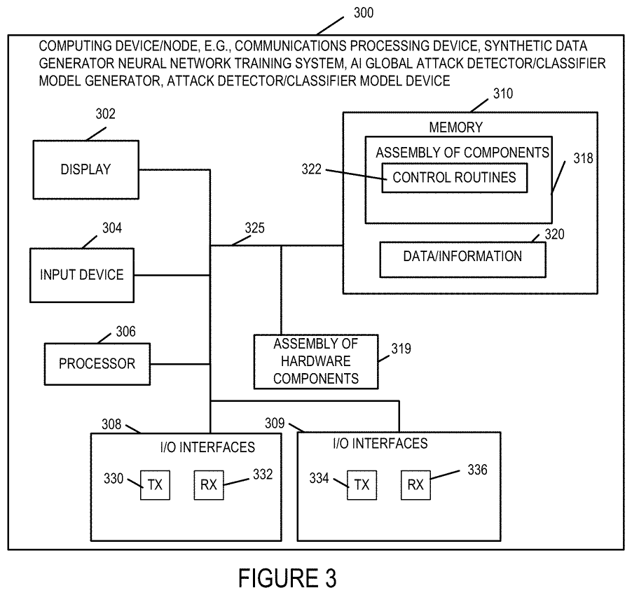

FIG. 3 illustrates an exemplary computing device/node in accordance with an embodiment of the present invention.

In some embodiments, one or more of the elements, nodes or components of the above mentioned system 100 are implemented in accordance with the exemplary computing device/node 300 illustrated in FIG. 3.

Exemplary computing device/node 300 includes an optional display 302, an input device 304, a processor 306, e.g., a CPU, I/O interfaces 308 and 309, which couple the computing device/node 300 to networks or communications links and/or various other nodes/devices, memory 310, and an assembly of hardware components 319, e.g., circuits corresponding to different components and/or modules, coupled together via a bus 325 over which the various elements may interchange data and information. Memory 310 includes an assembly of components 318, e.g., an assembly of software components, and data/information 320. The assembly of software components 318 includes a control routines component 322 which includes software instructions which when processed and executed by processor 306 control the operation of the computing device/node 300 to perform various functions and/or one or more steps of the various method embodiments of the invention. The I/O interface 308 includes transmitters 330 and receivers 332. The I/O interface 309 includes transmitters 334 and receivers 336. The I/O interfaces are hardware interfaces including hardware circuitry. The computing device/node 300 is also configured to have a plurality of Internet Protocol (IP) address/port number pairs, e.g., logical IP address/port pairs, for use in exchanging signaling information. In some embodiments the I/O interfaces include IP address/port pairs. The I/O interfaces in some embodiments are configured to communicate in accordance with the Session Initiation Protocol (SIP), Session Description Protocol (SDP), Internet Protocol (IP), Transport Control Protocol (TCP), User Datagram Protocol (UDP), WebRTC protocols, Representative State Transfer (REST) protocol, SQL (Structured Query Language) Protocol, and HDFS Hadoop Distributed File System Protocol, SQL and/or HDFS being used to interface and access information from the various databases and/or storage devices to which it may be coupled. In some embodiments, the computing device/node 300 includes a communication component configured to operate using SIP, SDP, IP, TCP, UDP, REST protocol, SQL (Structured Query Language), HDFS Hadoop Distributed File System. In some embodiments, the communications component is a hardware component, a software component or a component including hardware and software components. While only a single hardware processor is illustrated in some embodiments, it is to be understood that the computing device/node 300 can include more than one processor with the processing being distributed among the plurality of processors. In some embodiments, one or more of the following are implemented in accordance with the computing device/node 300 illustrated in FIG. 3: communications processing device 1 114, attack detector/classifier 116, synthetic data generator neural network training system 120, artificial intelligence global attack detector/global classifier model generator 112. In embodiments in which the synthetic data generator neural network training system 102 is implemented in accordance with the node 300, the processor 122 is implemented as processor 306, the I/O interfaces 126 are implemented as I/O Interfaces 308 and 309, the memory 124 is implemented as memory 310, the bus/communications link 136 is implemented as bus 325, feature extractor 128 is implemented in one or more of the components assembly of hardware components 319 or one or more of the assembly of software components 318 or a combination of hardware and software components 319 and 318, labeler classifier 130 is implemented in one or more of the components assembly of hardware components 319 or one or more of the assembly of software components 318 or a combination of hardware and software components 319 and 318, synthetic data generator neural network component 132 is implemented in one or more of the components assembly of hardware components 319 or one or more of the assembly of software components 318 or a combination of hardware and software components 319 and 318, discriminator classifier component 134 is implemented in one or more of the components assembly of hardware components 319 or one or more of the assembly of software components 318 or a combination of hardware and software components 319 and 318, the noise generator component 135 is implemented in one or more of the components assembly of hardware components 319 or one or more of the assembly of software components 318 or a combination of hardware and software components 319 and 318. In some embodiments, one or more of the feature extractor 128, labeler classifier 130, synthetic data generator neural network 132, discriminator 134 and/or noise generator 135 are implemented as separate nodes or devices in accordance with computing node/device 300. One or more of the devices, nodes, and or systems disclosed in FIG. 1 may be, and in some embodiments are, implemented in accordance with computing node/device 300.

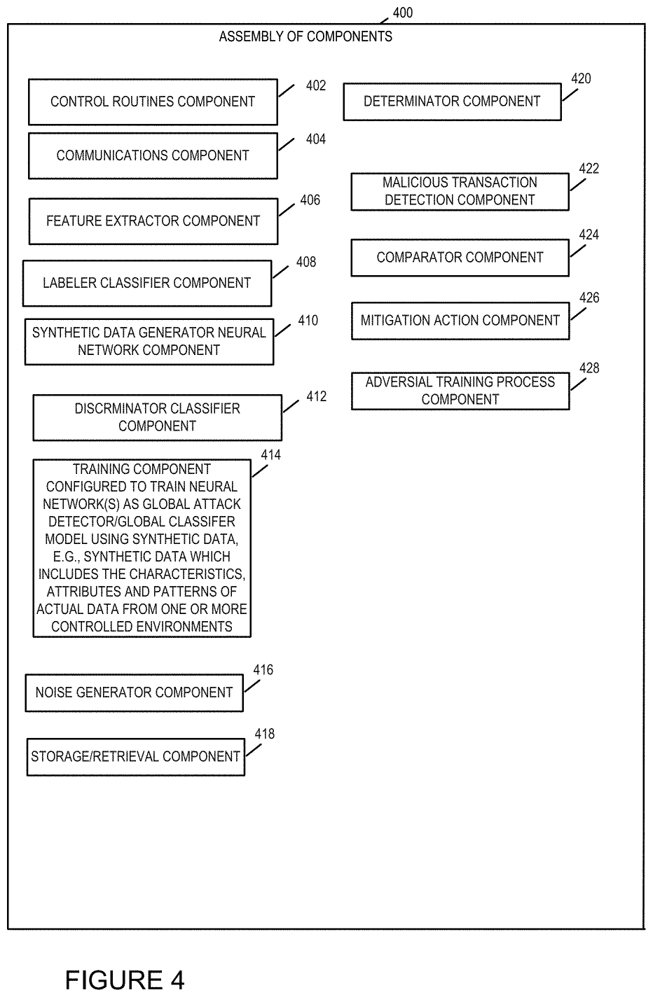

An exemplary assembly of components 400 for a computing node 300 in accordance with an embodiment of the present invention is illustrated in FIG. 4. One or more of the components of the assembly of components 400 may be implemented as hardware components in the assembly of hardware components 319 or as software components in the assembly of software components 318 stored in memory 310 of the exemplary computing node/device 300. One or more of the components of the assembly of components 300 may be used in the assembly of components depending on the features desired for use in the particular device, e.g., different components will be used for a synthetic data generator neural network training system than for the communications processing device 1 114 or the attack detector/classifier model device 116.

Assembly of components 400 can be, and in some embodiments is, used in computing node 300. The components in the assembly of components 400 can, and in some embodiments are, implemented fully in hardware within the processor 306, e.g., as individual circuits. The components in the assembly of components 400 can, and in some embodiments are, implemented fully in hardware within the assembly of components 319, e.g., as individual circuits corresponding to the different components. In other embodiments some of the components are implemented, e.g., as circuits, within the processor 306 with other components being implemented, e.g., as circuits within assembly of components 319, external to and coupled to the processor 306. As should be appreciated, the level of integration of components on the processor and/or with some components being external to the processor may be one of design choice. Alternatively, rather than being implemented as circuits, all or some of the components may be implemented in software and stored in the memory 310 of the computing node 300, with the components controlling operation of computing node 300 to implement the functions corresponding to the components when the components are executed by a processor, e.g., processor 306. In some such embodiments, the assembly of components 400 is included in the memory 310 as assembly of components 318. In still other embodiments, various components in assembly of components 400 are implemented as a combination of hardware and software, e.g., with another circuit external to the processor providing input to the processor 306 which then under software control operates to perform a portion of a component's function. While shown in the FIG. 3 embodiment as a single processor, e.g., computer, it should be appreciated that the processor 306 may be implemented as one or more processors, e.g., computers.

When implemented in software the components include code which, when executed by the processor 306, configure the processor 306 to implement the function corresponding to the component. In embodiments where the assembly of components 400 is stored in the memory 310, the memory 310 is a computer program product comprising a computer readable medium comprising code, e.g., individual code for each component, for causing at least one computer, e.g., processor 306, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 4 control and/or configure the computing node or device 300 or elements therein such as the processor 306, to perform the functions of corresponding steps described in one or more of the exemplary method embodiments described herein and/or described with respect to any of the Figures. Thus, the assembly of components 400 includes various components that perform functions of corresponding steps of one or more of method embodiments.

Assembly of components 400 includes components 402, 404, 406, 408, 410, 412, 414, 416, 418, 420, 422, 424, 426, and 428.

The control routines component 402 is configured to control the operation of the node or device.

The communications component 404 is configured to provide communications functionality including communications signaling and support for various communications protocols and interfaces. The communications component includes generating, sending, receiving and processing messages.

The feature extractor component 406 extracts a feature vector from transaction and/or request data, e.g., data corresponding a call, session and/or service request.

The labeler classifier component 408 labels data, e.g., a feature vector.

The synthetic data generator neural network component 410 when trained generates synthetic data which mimics the actual data (i.e., includes important characteristics, patterns, or attributes of the actual data) on which it was trained but does not include the confidential information or proprietary information of the actual data on which it was trained.

The discriminator classifier component 412 classifies or determines whether data, e.g., feature vectors, inputted into it are actual data or synthetic data during the training of synthetic data generator.

The training component 414 is configured to train neural networks as global attack detector/global classifier models using synthetic data, e.g., synthetic data which includes the characteristics, attributes and/or patterns of actual data from one or more controlled environments.

Noise generator component 416 generates and injects noise, e.g., Gaussian noise, into the synthetic data generator neural network during training.

Storage/retrieval component 418 stores and retrieves data from memory and/or databases.

Determinator component 420 makes various determinations including, for example, whether a feature vector is a synthetic feature vector or an actual feature vector, what mitigation action to be taken, whether a call is a malicious call or transaction, the probability a call, request or transaction is malicious, or whether a probability is above a threshold value.

The malicious transaction detection component 422 determines whether a transaction (e.g., call request, session request or service request is malicious (e.g., part of fraud call, denial of service attack, robocall attack).

The comparator component 424 compares values and items, e.g., probabilities to threshold values, feature vector sets, actual and fake data.

The mitigation action component 426 determines and/or performs a mitigation operation for example in response to the detection of a malicious transaction or a probability above a threshold that a transaction is malicious.

The adversarial training process component 428 trains both a generator neural network and a discriminator classifier together with the generator neural network being trained to maximize the final classification error while discriminator classifier is generated to minimize the final classification error.

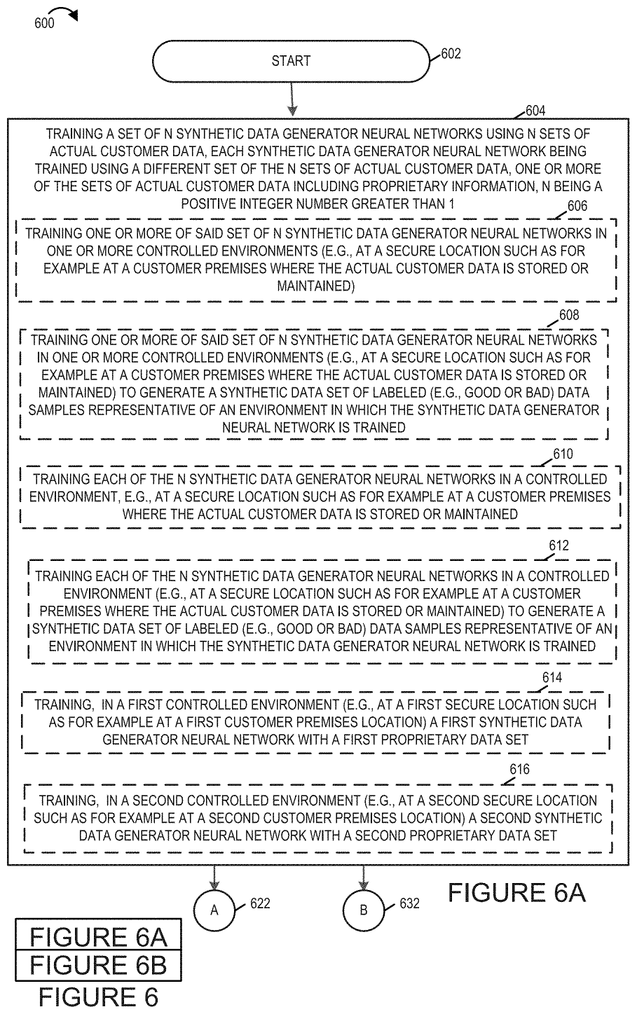

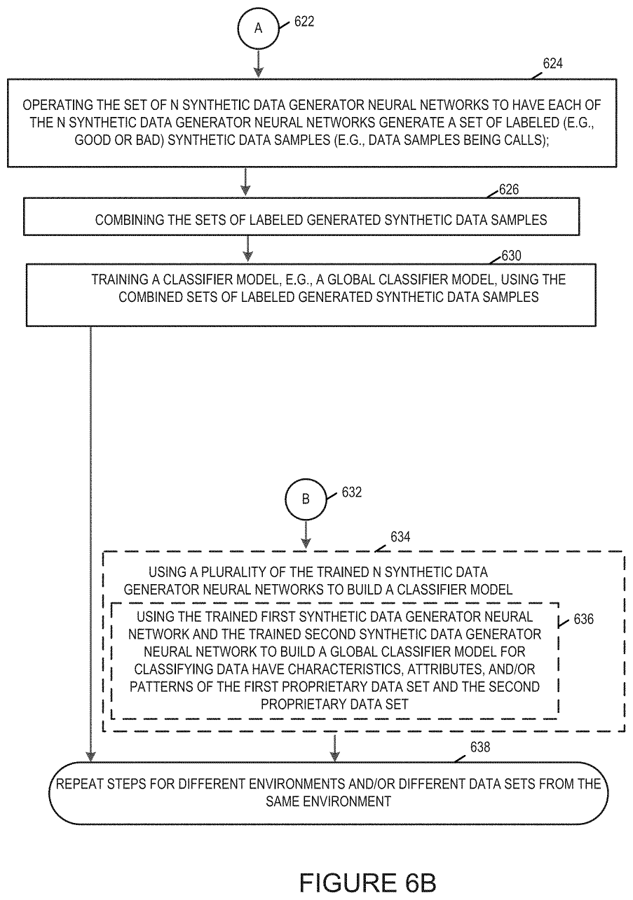

FIG. 6 illustrates a flowchart of an exemplary method 600 in accordance with one embodiment of the present invention. FIG. 6 comprises FIGS. 6A and 6B. FIG. 6A illustrates a first part of an exemplary method in accordance with an embodiment of the present invention. FIG. 6B illustrates a second part of an exemplary method in accordance with an embodiment of the present invention. The flowchart of method 600 illustrates the steps of an exemplary method of building, creating, generating and/or implementing synthetic data generator neural networks and generating synthetic data.

For explanatory purposes the exemplary method 600 will be explained in connection with the exemplary system 100 illustrated in FIG. 1. However, it should be understood that the method may be implemented using other systems and other system configurations then those illustrated in FIG. 1. While it will be readily understood that additional steps and signaling are performed in connection with communicating information, data, messages, and signals between devices, the method 600 focuses on and discusses the steps and/or signaling for understanding the invention.

The method 600 starts in start step 602 shown on FIG. 6A. Operation proceeds from start step 602 to step 604.

In step 604, a set of N synthetic data generator neural networks are trained using N sets of actual customer data. Each of the N synthetic data generator neural networks is trained using a different set of the N sets of actual customer data. One or more of the sets of actual customer data includes proprietary information. N is a positive integer number greater than 1. In some embodiments, N is a positive integer number greater than 5. In system 100 shown in FIG. 1 each of the controlled environments 102, 104, . . . , 106 includes a synthetic data generator neural network training system and a synthetic data generator neural network (e.g., synthetic data generator neural network 132 of synthetic data generator neural network training system 120 included in controlled environment 1). In various embodiments, the actual customer data is confidential and/or proprietary and contains confidential and/or proprietary information, e.g., belonging to the customer. In some embodiments, step 604, includes one or more sub-steps 606, 608, 610, 612, 614 and 616.

In sub-step 606, one or more of the set of N synthetic data generator neural networks is trained in one or more controlled environments (e.g., at a secure location such as for example at a customer premises where the actual customer data is stored or maintained).

In sub-step 608, one or more of the set of N synthetic data generator neural networks is trained in one or more controlled environments (e.g., at a secure location such as for example at a customer premises where the actual customer data is stored or maintained) to generate a synthetic data set of labeled (e.g., good or bad) data samples representative of an environment in which the synthetic data generator neural network is trained.

In sub-step 610, each of the N synthetic data generator neural networks is trained in a controlled environment (e.g., at a secure location such as for example at a customer premises where the actual customer data is stored or maintained.) For example, with respect to the system 100 of FIG. 1, each of the 1, 2, . . N synthetic data general neural networks would be trained within their respective controlled environments 1, 2, . . . , N. For example, the controlled environments may be, and in some embodiments are, customer premises 1, 2, . . , N which are secured and at which the actual customer data is maintained.

In sub-step 612, each of the N synthetic data generator neural networks is trained in a controlled environment (e.g., at a secure location such as for example at a customer premises where the actual customer data is stored or maintained) to generate a synthetic data set of labeled (e.g., good or bad) data samples representative of an environment in which the synthetic data generator neural network is trained.

In sub-set 614, a first synthetic data generator neural network is trained with a first proprietary data set in a first controlled environment (e.g., at a first secure location such as for example at a first customer premises location). For example, the synthetic data generator neural network 132 of synthetic data generator neural network training system 120 is trained in controlled environment 1 102 which may be, and in some embodiments is, a first customer's premises, the synthetic data generator neural network 132 being trained with a first proprietary data set of the first customer, e.g., call/session/service request detail records from database 118 which are maintained at the controlled environment 1 102.

In sub-set 616, a second synthetic data generator neural network is trained with a second proprietary data set in a second controlled environment (e.g., at a second secure location such as for example at a second customer premises location). For example, the synthetic data generator neural network included in the synthetic data generator neural network training system in the controlled environment 2 104 is trained in controlled environment 2 104 which may be, and in some embodiments is, a second customer's premises, the synthetic data generator neural network in the controlled environment 2 104 being trained with a second proprietary data set of the second customer, e.g., call/session/service request detail records from a database which is maintained at the controlled environment 2 104.

Operation proceeds from step 604 via connection node A 622 to step 624 shown on FIG. 6B and/or via connection node B 632 to optional step 634 shown on FIG. 6B.

In step 624, the set of N synthetic data generator neural networks are operated to have each of the N synthetic data generator neural networks generate a set of labeled (e.g., labeled good or bad) synthetic data samples (e.g., data samples being session or call data samples). Operation proceeds from step 624 to step 626.

In step 626, the N sets of labeled generated synthetic data samples are combined. Operation proceeds from step 626 to step 630.

In step 630, a classifier model, e.g., a global classifier model, or determinator is trained used the combined sets of labeled generated synthetic data samples. Operation proceeds from step 630 to step 636.

Returning now to step 634, in step 634, a plurality of the trained N synthetic data generator neural networks is used to build, generate, create and/or implement a classifier model or determinator. In some embodiments, step 634 includes sub-step 636. In sub-step 636, the trained first synthetic data generator neural network and the trained second synthetic data generator neural network are used to build, generate, create and/or implement a global classifier model for classifying data having characteristics, attributes, and/or patterns of the first proprietary data set and the second proprietary data set. While only two trained synthetic data generator neural networks have been described, any plurality of the N trained synthetic data generator neural networks may be used to generate the global classifier or determinator. Operation proceeds from step 634 to step 638.

In step 638, the method is repeated for different environments and/or different data sets from the same environment.

In various embodiments, upon completing the training of the N synthetic data generator neural networks, each synthetic data generator neural network is able to generate a synthetic data set of labeled (e.g., good and bad) data samples representative of an environment in which the synthetic data generator neural network was trained with the generated synthetic data set not including any of the proprietary information of the training data set.

In various embodiments, the synthetic data generated by each of the synthetic data generator neural networks includes data samples which are representative of the controlled environment in which the synthetic data generator was trained while not including any actual customer data and/or excluding any proprietary customer data. In some such embodiments, as the synthetic data generator neural networks generate synthetic data which does not include any actual customer data/information and excludes proprietary customer data/information, the synthetic data generator neural networks may be relocated to non-controlled, e.g., non-secure environment where a classifier model may be generated and/or synthetic data sets may be generated. Alternatively, the synthetic data sets may be generated in a controlled environment and the synthetic data may then be relocated to a non-controlled, e.g., non-secure environment, where the synthetic data may be used to train a classifier model or a malicious detection system including a classifier model. Relocating a synthetic data generator neural network in some embodiments includes extracting the synthetic data generator neural network from a synthetic data generator neural network training system or device after completion of the synthetic data generator neural networks training. In some embodiments, relocating a synthetic data general neural network includes extracting the parameters which define the synthetic data generator neural network (e.g., number neural network nodes, structure, and link weights connecting the nodes) and recreating or replicating the trained synthetic data generator neural network using the extracted parameters at a new location on different hardware.

In various embodiments, proprietary and/or confidential information is information or includes information from which the customer and/or a user can be identified. In various embodiments, proprietary and/or confidential data is data or includes data from which the customer and/or a user can be identified.

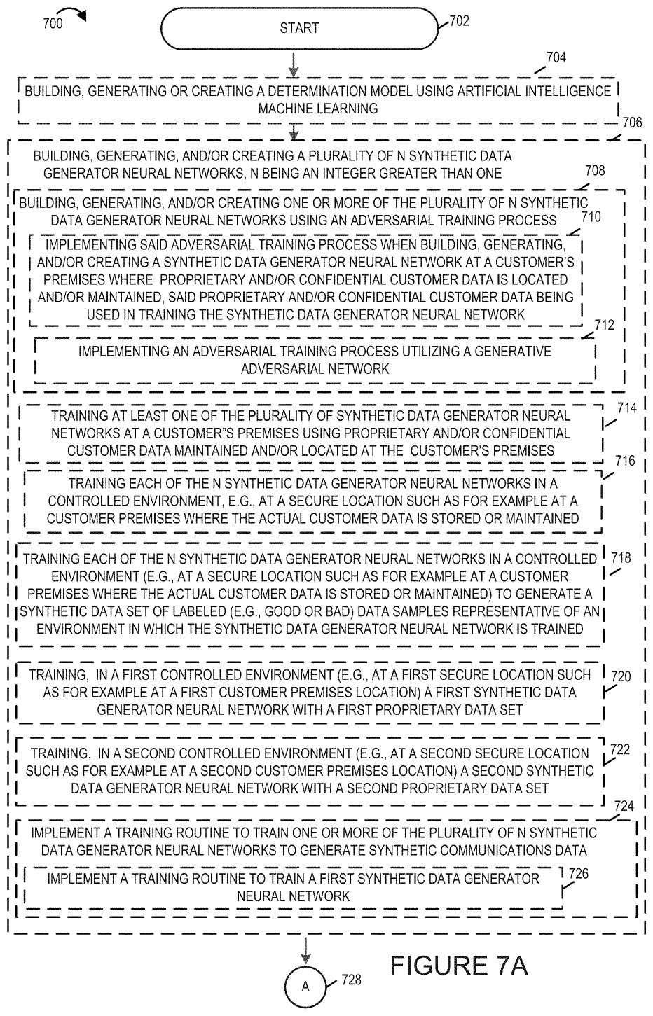

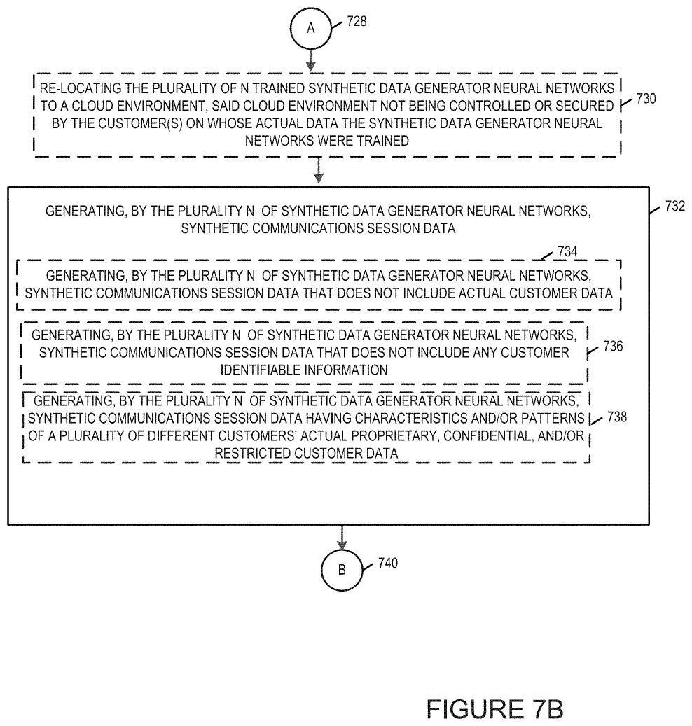

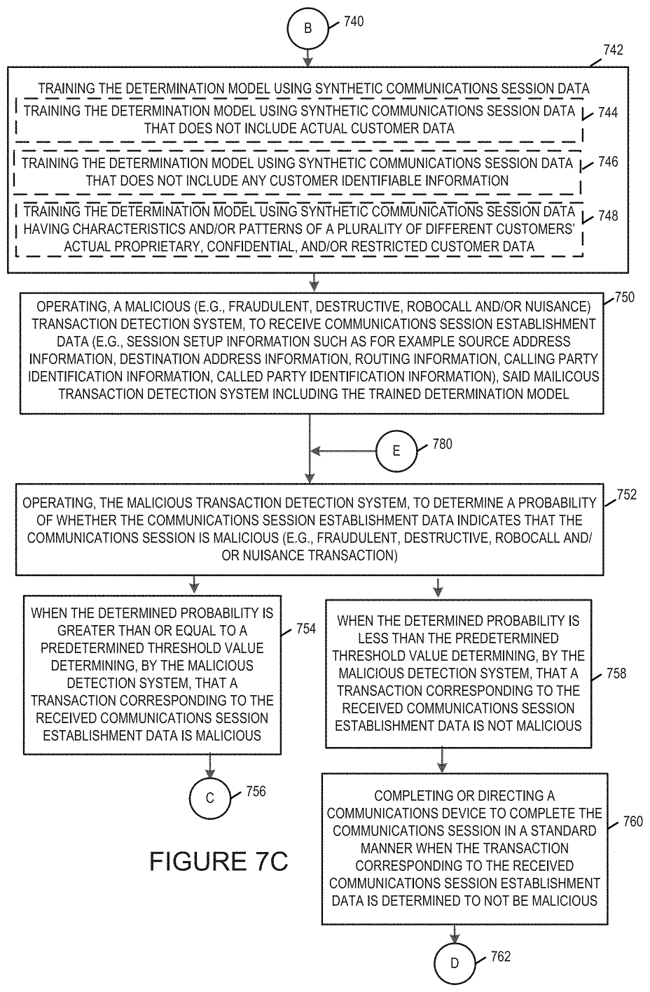

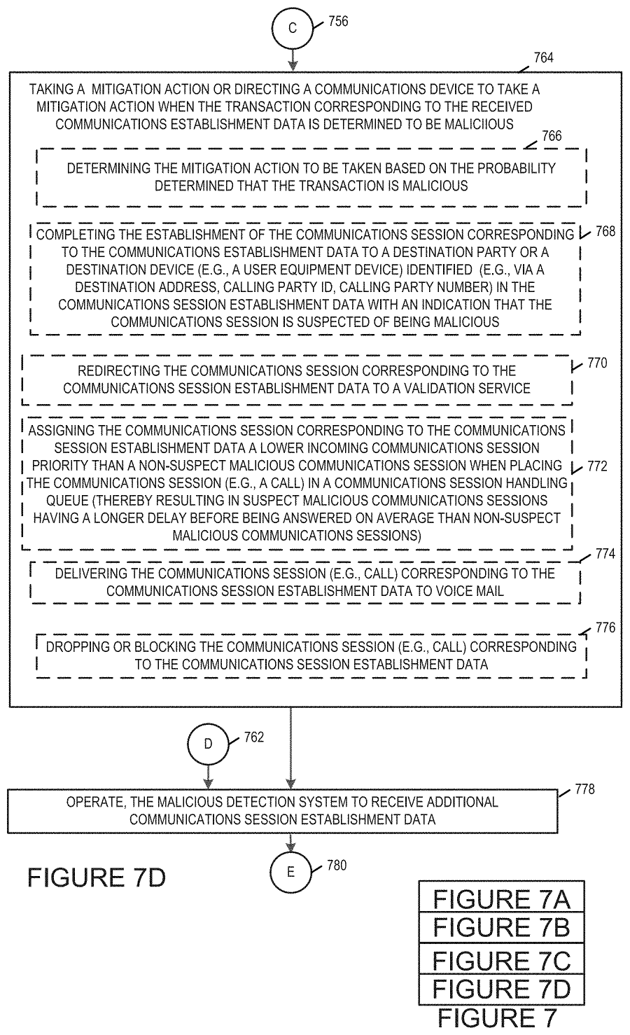

FIG. 7 comprises FIGS. 7A, 7B, 7C, and 7D. FIG. 7A illustrates a first part of an exemplary method in accordance with an embodiment of the present invention. FIG. 7B illustrates a second part of an exemplary method in accordance with an embodiment of the present invention. FIG. 7C illustrates a third part of an exemplary method in accordance with an embodiment of the present invention. FIG. 7D illustrates a fourth part of an exemplary method in accordance with an embodiment of the present invention. For explanatory purposes the exemplary method 700 will be explained in connection with the exemplary system 100 illustrated in FIG. 1. However, it should be understood that the method may be implemented using other systems and other system configurations then those illustrated in FIG. 1. While it will be readily understood that additional steps and signaling are performed in connection with communicating information, data, messages, and signals between devices, the method 700 focuses on and discusses the steps and/or signaling for understanding the invention.

The method 700 starts in start step 702 shown on FIG. 7A. Operation proceeds from start step 702 to step 704.

In step 704, a determination model using artificial intelligence machine learning is built, generated, created and/or implemented for example by an artificial intelligence global attack detector/global classifier model generator (e.g., artificial intelligence global attack detector/global classifier model generator 112 of system 100). Operation proceeds from step 704 to step 706.

In step 706, a plurality of N synthetic data generator neural networks is built, generated, created and/or implemented. N is an integer greater than one. In some embodiments, N is two. In some embodiments, N is an integer number greater than 10. In some embodiments step 706 includes one or more sub-steps 708, 714, 716, 718, 720, 722, and 724.

In sub-step 708, one or more of the plurality of N synthetic data generator neural networks is built, generated, created and/or implemented using an adversarial training process. In some embodiments, sub-step 708 includes one or more sub-steps 710 and 712.

In sub-step 710, the adversarial training process used when building, generating, creating and/or implementing a synthetic data generator neural network is performed at a customer's premises where proprietary and/or confidential customer data is located and/or maintained. The proprietary and/or confidential customer data is used in training the synthetic data generator neural network.

In sub-step 712, an adversarial training process utilizing a generative adversarial network is implemented when building, generating, creating and/or implementing a synthetic data generator neural network.

In sub-step 714, training is performed on at least one of the plurality of synthetic data generator neural networks at a customer's premises using proprietary and/or confidential customer data maintained and/or located at the customer's premises.

In sub-step 716, each of the N synthetic data generator neural networks is trained in a controlled environment, e.g., at a secure location such as for example at a customer premises where the actual customer data is stored or maintained.

In sub-step 718, each of the N synthetic data generator neural networks is trained in a controlled environment (e.g., at a secure location such as for example at a customer premises where the actual customer data is stored or maintained) to generate a synthetic data set of labeled (e.g., good or bad) data samples representative of an environment in which the synthetic data generator neural network is trained.

In sub-step 720, training in a first controlled environment (e.g., at a first secure location such as for example at a first customer premises) a first synthetic data generator neural network with a first proprietary data set (e.g., a first proprietary customer data set including session transaction information) to generate a first synthetic data set of labeled (e.g., good or bad) data samples (e.g., the first synthetic data set consisting of data samples including the characteristics, attributes and/or patterns of the first proprietary data set used to train the first synthetic data generator neural network).

In sub-step 722, training in a second controlled environment (e.g., at a second secure location such as for example at a second customer premises) a second synthetic data generator neural network with a second proprietary data set (e.g., a second proprietary customer data set including session transaction information) to generate a second synthetic data set of labeled (e.g., good or bad) data samples (e.g., the second synthetic data set consisting of data samples including the characteristics, attributes and/or patterns of the second proprietary data set used to train the second synthetic data generator neural network). While the training of two synthetic data generator neural networks have been described, the process may be extended to any number of the N synthetic data generator neural networks.

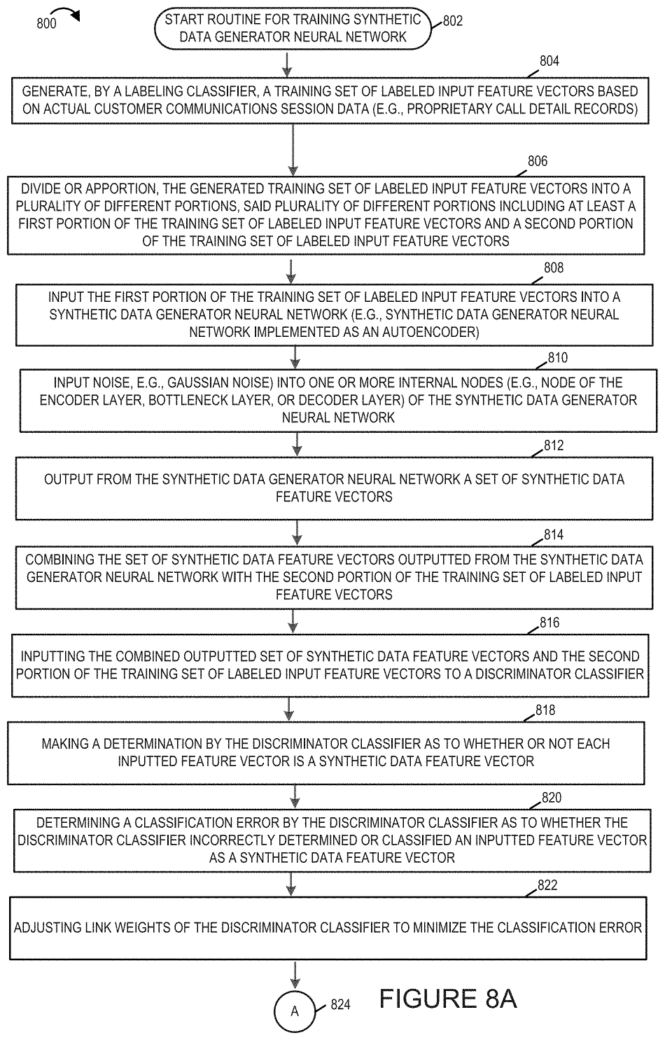

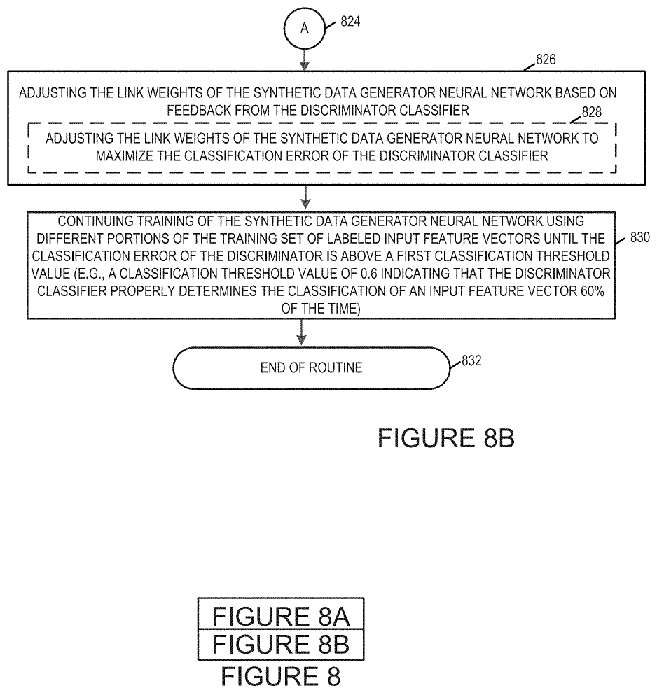

In sub-step 724, a training routine or method is implemented to train one or more of the plurality of N synthetic data generator neural networks to generate synthetic communications data. In some embodiments sub-step 724 includes sub-step 726. In sub-step 726, a training routine is implemented to train a first synthetic data generator neural network. In some various embodiments, training routine is implemented a sub-routine that is called by the method 700. In some embodiments, the training routine is training routine 800 illustrated in FIG. 8. Operation proceeds from step 706 via connection node A 728 to optional step 730 shown on FIG. 7B. If optional step 730 is not implemented, operation proceeds to step 732.

In step 730, the plurality of N trained synthetic data generator neural networks are re-located to a cloud environment. In various embodiments, the cloud environment is not a controlled or secured by the customer(s) on whose actual data the synthetic data generator neural networks were trained. Operation proceeds from step 730 to step 732.

In step 732, synthetic communications session data is generated by the plurality N of synthetic data generator neural networks. In some embodiments, step 732 includes one or more sub-steps 734, 736 and 738.

In sub-step 734, synthetic communications session data that does not include actual customer data is generated by the plurality N of synthetic data generator neural networks.

In sub-step 736, synthetic communications session data that does not include any customer identifiable information is generated by the plurality of N synthetic data generator neural networks.

In sub-step 738, synthetic communications session data having the characteristics and/or patterns of a plurality of different customers' actual proprietary, confidential, and/or restricted customer data is generated by the plurality of N synthetic data generator neural networks. Operation proceeds from step 732 via connection node B 740 to step 742 shown on FIG. 7C.

In step 742, the synthetic communications session data is used to train the determination model. In some embodiments step 742 includes one or more sub-steps 744, 746 and 748.

In sub-step 744, the determination model is trained using synthetic communications session data that does not include actual customer data.

In sub-step 746, the determination model is trained using synthetic communications session data that does not include any customer identifiable information.

In sub-step 748, the determination model is trained using synthetic communications session data having the characteristics and/or patterns of a plurality of different customers actual proprietary, confidential, and/or restricted customer data.

Operation proceeds from step 742 to step 750. In step 750, a malicious (e.g., fraudulent, destructive, robocall and/or nuisance) transaction detection system is operated to receive communications session establishment data (e.g., session setup information such as for example source address information, destination address information, routing information, calling party identification information, called party identification information), the malicious transaction detection system including the trained determination model. Operation proceeds from step 750 to step 752.

In step 752, the malicious transaction detection system is operated to determine a probability of whether the communications session establishment data indicates that the communications session is malicious (e.g., fraudulent, destructive, robocall and/or nuisance transaction). Operation proceeds from step 752 to step 754 when the determined probability is greater than or equal to a predetermined threshold value. Operation proceeds from step 752 to step 758 when the determined probability is less than the predetermined threshold value.

In step 754, when the determined probability is greater than or equal to the predetermined threshold value, the malicious detection system determines that a transaction corresponding to the received communications session establishment data is malicious. Operation proceeds from step 754 via connection node C 756 to step 764.

In step 758, when the determined probability is less than the predetermined threshold value, the malicious detection system determines that a transaction corresponding to the received communications session establishment data is not malicious. Operation proceeds from step 758 to step 760.

In step 760, the malicious transaction detection system either completes or directs a communications device to complete the communications session corresponding to the received communications session establishment data in a standard manner when the transaction corresponding to the received communications session establishment data is determined to not be malicious. Operation proceeds from step 760 via connection node D 762 to step 778.

Returning to step 764, in step 764, the malicious transaction detection system either takes a mitigation action or directions a communications device to take a mitigation action when the transaction corresponding to the received communications session establishment data is determined to be malicious. In some embodiments step 764 includes one or more sub-steps 766, 768, 770, 772, 774 and 776.

In sub-step 766, the mitigation action to be taken by the malicious transaction detection system is determined based on the probability determined that the transaction is malicious.

In sub-step 768, the establishment of the communications session corresponding to the communications establishment data is completed to a destination party or a destination device (e.g., a user equipment device) identified (e.g., via a destination address, calling party ID, calling party number) in the communications session establishment data with an indication that the communications session is suspected of being malicious.

In sub-step 770, the communications session corresponding to the communications session establishment data is redirected to a validation service.

In sub-step 772, the communications session corresponding to the communications session establishment data is assigned a lower incoming communications session priority than a non-suspect malicious communications session when placing the communications session (e.g., a call) in a communications session handling queue (thereby resulting in suspect malicious communications sessions having a longer delay before being answered on average than non-suspect malicious communications sessions.).

In sub-step 774, the communications session (e.g., call) corresponding to the communications session establishment data is delivered to voice mail or a voice mail service.

In sub-step 776, the communications session (e.g., call) corresponding to the communications session establishment data is dropped or blocked.

The communications session corresponding to the communications session establishment data is the communications session to which the communications session establishment data belongs.

Operation proceeds from step 764 to step 778.

In step 778, the malicious detection system operates to receive additional communications session establishment data for another communications sessions. Operation proceeds from step 778 via connection node E 780 to step 752 where the steps of method 700 continue with the additional communications session establishment data being used in place of the communications session establishment data, i.e., the additional communications session is evaluated for being a malicious transaction and processed accordingly.

In some embodiments, the attack detector/classifier model 116 of system 100 is a malicious transaction detection system which performs the operations and/functions described in the method 700. In various embodiments, the artificial intelligence global attack detection/global classifier model generator 112 of system 100 generates and/or trains the malicious transaction detection system as described in method 700. In various embodiments, the synthetic data generator neural network training system 120 of system 100 performs the functions and operations of building, generating, creating and/or implementing at least one of the plurality of synthetic data generator neural networks described in the method 700 e.g., in the controlled environment 1 102 using customer call/session/service request detail records stored in database 118. In various embodiments, each of the other controlled environments 2 104, . . . , N 106 of system 100 includes a synthetic data generator neural network training system the same as or similar to synthetic data generator neural network training system 120 which builds, creates, generates and/or implements a different one of the plurality of N synthetic data generator neural networks.

In various embodiments, steps 704, 706, and 730 are optional.

FIG. 8 comprises FIGS. 8A and 8B. FIG. 8A illustrates a first part of an exemplary method or routine in accordance with an embodiment of the present invention. FIG. 8B illustrates a second part of an exemplary method in accordance with an embodiment of the present invention. For explanatory purposes the exemplary method or routine 800 will be explained in connection with the exemplary system 100 and in particular with the synthetic data generator neural network training system 120 illustrated in FIG. 1. However, it should be understood that the method 800 also referred to herein as a routine may be implemented using other systems and other system configurations then those illustrated in FIG. 1. While it will be readily understood that additional steps and signaling are performed in connection with communicating information, data, messages, and signals between devices, the method 800 focuses on and discusses the steps and/or signaling for understanding the invention.

The method 800 is an exemplary routine for a training synthetic data generator neural network in accordance with one embodiment of the present invention.

The method 800 starts in start step 802 shown on FIG. 8A. Operation proceeds from start step 802 to step 804.

In step 804, a labeling classifier (e.g., labeling classifier 130 of synthetic data generator neural network training system 120 of system 100 shown in FIG. 1) generates a training set of labeled input feature vectors based on actual customer communications session data (e.g., proprietary call detail records received from database 118). Operation proceeds from step 804 to step 806.

In step 806, the synthetic data generator neural network training system 120 divides and/or apportions the generated training set of labeled input feature vectors into a plurality of different portions, said plurality of different portions including at least a first portion of the training set of labeled input feature vectors and a second portion of the training set of labeled input feature vectors. Operation proceeds from step 806 to step 808.

In step 808, the synthetic data generator neural network training system 120 inputs the first portion of the training set of labeled input feature vectors into a synthetic data generator neural network (e.g., synthetic data generator neural network 132 of synthetic data generator neural network training system 120 of system 100 shown in FIG. 1). In some embodiments, the synthetic data generator neural network is implemented as an autoencoder neural network (e.g., autoencoder neural network 200 shown in FIG. 2). Operation proceeds from step 808 to step 810.

In step 810, noise is input into one or more internal nodes of the synthetic data generator neural network by a noise generator (e.g., noise generator 135 of synthetic data generator neural network training system 120 of system 100 illustrated in FIG. 1). In some embodiments, the noise input into the synthetic data generator neural network is gaussian noise, that is the noise has a gaussian distribution. In some embodiments, the noise generator is a gaussian noise generator. In some embodiments in which the synthetic data generator neural network is an autoencoder, the noise is injected or input into one or more nodes of the encoder layer, the bottleneck layer or the decoder layer of the autoencoder. Operation proceeds from step 810 to step 812.

In step 812, the synthetic data generator neural network outputs a set of synthetic data feature vectors. Operation proceeds from step 812 to step 814.

In step 814, the synthetic data generator neural network training system is operated (e.g., by processor 122 of synthetic data generator neural network training system 120 of system 100 shown in FIG. 1) to combine the set of synthetic data feature vectors outputted from the synthetic generator neural network with a second portion of the training set of labeled input feature vectors. Operation proceeds from step 814 to step 816.

In step 816, the combined outputted set of synthetic data feature vectors and the second portion of the training set of labeled input feature vectors is input to a discriminator classifier or determinator (e.g., discriminator classifier 134 of synthetic data generator neural network training system 120 of system 100 shown in FIG. 1). Operation proceeds from step 816 to step 818.

In step 818, the discriminator classifier makes a determination as to whether or not each inputted feature vector is a synthetic data feature vector. Operation proceeds from step 818 to step 820.

In step 820, determining (e.g., by the synthetic data generator neural network training system 120 of system 100 shown in FIG. 1) a classification error as to whether the discriminator classifier incorrectly determined or classified an inputted feature vector as a synthetic data feature vector. Operation proceeds from step 820 to step 822.

In step 822, the link weights of the discriminator classifier are adjusted to minimize the classification error. Operation proceeds from step 822 to step 826 shown on FIG. 8B via connection node A 824.

In step 826, the link weights of the synthetic data generator neural network are adjusted based on feedback received from the discriminator classifier. In some embodiments, step 826 includes sub-step 828. In sub-step 828, the link weights of the synthetic data generator neural network are adjusted to maximize the classification error of the discriminator classifier. Operation proceeds from step 826 to step 830.

In step 830, training of the synthetic data generator neural network continues using different portions of the training set of labeled input feature vectors until the classification error of the discriminator is above a first classification threshold value. In some embodiments, the first classification threshold value is 0.4 which indicates that the discriminator classifier properly determines that classification of an input feature vector 60% of the time. In some embodiments, the first classification threshold value is 0.5 which indicates that the discriminator classifier properly determines that classification of an input feature vector 50% of the time. Operation proceeds from step 830 to step 832.

Step 832 is an end of the routine or method 800. In some embodiments, if the routine had been called from another routine or method, the routine or method will return an indication of the classification threshold value to which the synthetic data generator neural network was trained to the routine or method which called routine 800.

In some embodiments, the first classification threshold value is inputted or passed to the routine 800, when the routine is called. In such embodiments a user or operator of the synthetic data generator neural network training system 120 can specify the classification threshold value to use for the training of the synthetic data generator neural network which provides additional flexibility in determining the quality and amount of time spent in training the synthetic data generator neural network.

In various embodiments, the training of the synthetic data generator neural network continues until the classification error of the discriminator is within a first classification threshold range for a threshold number of synthetic data sample sets generated by the synthetic data generator neural network. In some of the embodiments, the threshold number of synthetic data sample sets must be consecutively generated by the synthetic data generator neural network. In some embodiments, the first classification threshold range includes a first classification threshold range value and a second classification threshold range value. In some such embodiments the first classification threshold range value is 0.40 which indicates that the discriminator classifier properly determines the classification of an input feature vector 60% of the time and the second classification threshold range value is 0.45 which indicates that the discriminator classifier properly determines the classification of an input feature vector 55% of the time. In another embodiment, the first classification threshold range value is 0.39 and the second classification threshold range value is 0.44. In some embodiments, the first classification threshold range value is 0.40 and the second classification threshold range is 0.49. In various embodiments, the first classification threshold range includes the first and second classification threshold range values. In some other embodiments, the first classification threshold range excludes the first and second classification threshold range values. In some embodiments, the first classification error value of the discriminator is output to a file or display, and an operator determines when the training is complete such as, for example, when the outputted value is within a first classification threshold range for a period of time or for a number of sample sets.

List of Exemplary Numbered Method Embodiments:

Method Embodiment 1. A method for detecting malicious (e.g., fraudulent, destructive, robocall and/or nuisance) transactions comprising: operating a malicious (e.g., fraudulent, destructive, robocall and/or nuisance) transaction detection system to receive communications session establishment data (e.g., session setup information such as for example source address information, destination address information, routing information, calling party identification information, called party identification information, etc.); operating the malicious transaction detection system to determine a probability of whether the communications session establishment data indicates that the communications session is malicious (e.g., fraudulent, destructive, robocall and/or nuisance transaction); and when the determined probability is greater than or equal to a predetermined threshold value determining that a transaction corresponding to the received communications session establishment data is malicious; and when the determined probability is less than the predetermined threshold value determining that the transaction corresponding to the received communications session establishment data is not malicious; and wherein the malicious transaction detection system includes a determination model (e.g., classifier model) trained using synthetic communications session data.

Method Embodiment 1A. The method of Method Embodiment 1 further comprising: completing or directing a communications device to complete the communications session establishment in a standard manner when the transaction corresponding to the received communications session establishment data is determined to not be malicious.

Method Embodiment 1B. The method of Method Embodiment 1 further comprising: taking at least one mitigation action or directing a communications device to take at least one mitigation action when the transaction corresponding to the received communications session establishment data is determined to be malicious.

Method Embodiment 1C. The method of Method Embodiment 1B further comprising: determining the mitigation action to be taken based on the probability determined that the transaction is malicious.

Method Embodiment 1D. The method of Method Embodiment 1B, wherein the taking at least one mitigation action includes taking one or more of the following actions: i) completing the establishment of the communications session corresponding to the communications session establishment data to a destination party or a destination device (e.g., a user equipment device) identified (e.g., via a destination address, called party ID, called party number) in the communications session establishment data with an indication that the communications session is suspected of being malicious; ii) redirecting the communications session corresponding to the communications session establishment data to a validation service; iii) assigning the communications session corresponding to the communications session establishment data a lower incoming communications session (e.g., call) priority than a non-suspect malicious communications session when placing the communications session (e.g., call) in a communications session (e.g., call) handling queue (thereby resulting in suspect malicious communications sessions having a longer delay before being answered on average than non-suspect malicious communications sessions); iv) delivering the communications session (e.g., call) corresponding to the communications session establishment data to voice mail; or v) dropping or blocking the communications session (e.g., call) corresponding to the communications session establishment data.

Method Embodiment 2. The method of Method Embodiment 1, wherein the determination model is built, generated, or created using artificial intelligence machine learning.

Method Embodiment 3. The method of Method Embodiment 1, wherein the synthetic communications session data is generated by a plurality of synthetic data generator neural networks; wherein one or more of the plurality of synthetic data generator neural networks is trained using proprietary and/or confidential customer data.

Method Embodiment 3A. The method of Method Embodiment 1, wherein the synthetic communications session data does not include actual customer data.

Method Embodiment 3B. The method of Method Embodiment 1, wherein the synthetic communications session data does not include any customer identifiable information.

Method Embodiment 3C. The method of Method Embodiment 3B, wherein the synthetic communications session data includes the characteristics and patterns of a plurality of different customers' actual proprietary, confidential and/or restricted customer data.

Method Embodiment 4. The method of Method Embodiment 3, wherein the synthetic communications session data is generated by a plurality of synthetic data generator neural networks; and wherein said one or more of the plurality of synthetic data generator neural networks is trained using actual proprietary or confidential customer data includes at least two synthetic data generator neural networks.

Method Embodiment 5. The method of Method Embodiment 3, wherein one or more of the plurality of synthetic data generator neural networks are built, created or generated using an adversarial training process; wherein said adversarial training process is implemented at a customer's premises where said proprietary and/or confidential customer data is located and/or maintained.

Method Embodiment 6. The method of Method Embodiment 5, wherein the adversarial training process utilizes a Generative Adversarial Network.

Method Embodiment 7. The method of Method Embodiment 4, wherein one or more of the plurality of synthetic data generator neural networks is trained at a customer's premises using proprietary and/or confidential customer data maintained or located at the customer's premises.

Method Embodiment 8. The method of Method Embodiment 7, wherein each of the synthetic data generator neural networks after being trained are re-located to a cloud environment, said cloud environment not being controlled or secured by the customer or customers on whose actual data the synthetic data generator neural network was trained.

Method Embodiment 8A. The method of Method Embodiment 7, wherein each of the one or more of the plurality of synthetic data generator neural networks is trained at a different customer premises using a different set of customer data.

Method Embodiment 8B. The method of Method Embodiment 8A, wherein each of the synthetic data generator neural networks after being trained is re-located to a cloud environment.

Method Embodiment 8C. The method of Method Embodiment 8B, wherein the cloud environment is not controlled or secured by the customers whose customer data was used for training the synthetic data generator neural networks.

Method Embodiment 9. The method of Method Embodiment 3, wherein one or more of the synthetic data generator neural networks is a variational autoencoder neural network.

Method Embodiment 10. The method of Method Embodiment 1 further comprising: generating said synthetic communications session data used for training the malicious transaction detection system using a plurality of synthetic data generator neural networks, said plurality of synthetic data generator neural networks each being trained using separate proprietary session transaction data sets obtained from customer session transaction records (e.g., CDRs).

Method Embodiment 11. The method of Method Embodiment 10 further comprising: prior to generating said synthetic communications session data, training a first synthetic data generator neural network to generate synthetic communications session data, said first synthetic data generator neural network being one of said plurality of synthetic data generator neural networks.

Method Embodiment 12. The method of Method Embodiment 11, wherein the first synthetic data generator neural network is an autoencoder neural network: wherein said training the first synthetic data generator neural network includes: generating, by a labeling classifier, a training set of labeled input feature vectors based on actual customer communications session data (e.g., proprietary call detail records); inputting a first portion of the training set of labeled input feature vectors into the first synthetic data generator neural network; inputting noise (e.g., Gaussian noise) into one or more internal nodes (e.g., nodes of the encoder, bottleneck or decoder layers) of the synthetic data generator neural network; outputting from the first synthetic data generator neural network a set of synthetic data feature vectors; combining the outputted set of synthetic data feature vectors with a second portion of the training set of labeled input feature vectors; inputting the combined outputted set of synthetic data feature vectors and second portion of the training set of labeled input feature vectors to a discriminator classifier; making a determination by the discriminator classifier as to whether each inputted feature vector is a synthetic data feature vector; adjusting the link weights of the first synthetic data generator neural network based on feedback from the discriminator classifier.

Method Embodiment 13. The method of Method Embodiment 12 further comprising: determining a classification error by the discriminator classifier as to whether the discriminator classifier incorrectly determined or classified an inputted feature vector as a synthetic data feature vector; adjusting link weights of the discriminator classifier to minimize the classification error; and wherein said adjusting the link weights of the first synthetic data generator neural network based on feedback from the discriminator classifier includes adjusting the link weights to maximize the classification error of the discriminator classifier.

Method Embodiment 14. The method of Method Embodiment 13, wherein training of the first synthetic data generator neural network continues until the classification error of the discriminator is above a first classification error threshold value.

Method Embodiment 14A. The method of Method Embodiment 13, wherein training of the first synthetic data generator neural network continues until the classification accuracy of the discriminator is below a first classification accuracy threshold value.

Method Embodiment 15. The method of Method Embodiment 14, wherein the first classification error threshold value is 0.4 indicating that the discriminator classifier properly determines the classification of an input feature vector 60% of the time.

Method Embodiment 15A. The method of Method Embodiment 14, wherein the first classification error threshold value is 0.5 indicating that the discriminator classifier properly determines the classification of an input feature vector 50% of the time.

Method Embodiment 15B. The method of Method Embodiment 14A, wherein the first classification accuracy threshold value is 0.6 indicating that the discriminator classifier accurately determines the classification of an input vector 60% of the time.

Method Embodiment 16. A method of generating synthetic data comprising: training a set of N synthetic data generator neural networks using N sets of actual customer data, each synthetic data generator neural network being trained using a different set of the N sets of actual customer data, one or more of the N sets of actual customer data including proprietary information, N being a positive integer number greater than 1; upon completing the training of the N synthetic data generator neural networks, each synthetic data generator neural network is able to generate a synthetic data set of labeled (e.g., good and bad) data samples representative of an environment in which the synthetic data generator neural network is trained, the generated synthetic data set not including any of the proprietary information of the training data set.

Method Embodiment 17. The method of Method Embodiment 16 further comprising: wherein each of the synthetic data generator neural networks, which is trained using actual customer data including proprietary information, is trained in a controlled environment (e.g., at a secure location, e.g., customer premises, where the actual customer data is stored or maintained); and wherein synthetic data generated by each of the synthetic data generator neural networks, which is trained using actual customer data including proprietary information, includes data samples which are representative of the controlled environment in which the synthetic data generator was trained.

Method Embodiment 18. The method of Method Embodiment 17 further comprising: operating the set of N synthetic data generator neural networks to each generate a set of labeled (e.g., good or bad) synthetic data samples (e.g., data samples being calls); combining the sets of labeled generated synthetic data samples (e.g., calls); training a classifier model using the combined sets of labeled generated synthetic data samples (e.g., calls).

Method Embodiment 19. The method of Method Embodiment 16 further comprising: using a plurality of the trained N synthetic data generator neural networks to build a classifier model.

Method Embodiment 20. The method of Method Embodiment 17, wherein N is 2; and wherein said training a set of N synthetic data generator neural networks using N sets of actual customer data includes: training, in a first controlled environment (e.g., first customer premises location), a first synthetic data generator neural network with a first proprietary data set; training, in a second controlled environment (e.g., second customer premises location), a second synthetic data generator neural network with a second proprietary data set; and wherein the trained first synthetic data generator neural network and the trained second synthetic data generator neural networks are used to generate a global classifier model for classifying data having the characteristics, attributes and/or patterns of the first proprietary data set and the second priority data set.

Method Embodiment 21. The method of Method Embodiment 16, wherein proprietary information is information from which the customer or a user can be identified.

List of Exemplary Numbered System/Apparatus Embodiments:

System Embodiment 1. A system comprising: a malicious (e.g., fraudulent, destructive, robocall and/or nuisance) transaction detection device including: memory; and a first processor, the first processor controlling the malicious transaction detection device to perform the following operations: receive communications session establishment data (e.g., session setup information such as for example source address information, destination address information, routing information, calling party identification information, called party identification information, etc.); determine a probability of whether the communications session establishment data indicates that the communications session is malicious (e.g., fraudulent, destructive, robocall and/or nuisance transaction); and when the determined probability is greater than or equal to a predetermined threshold value determining that a transaction corresponding to the received communications session establishment data is malicious; and when the determined probability is less than the predetermined threshold value determining that the transaction corresponding to the received communications session establishment data is not malicious; and wherein the malicious transaction detection device further includes a determination model (e.g., classifier model) trained using synthetic communications session data to classify communications session establishment data as good or bad.

System Embodiment 1A. The system of System Embodiment 1, wherein the first processor further controls the malicious transaction detection device to perform the following operation: complete or direct a communications device to complete the communications session establishment in a standard manner when the transaction corresponding to the received communications session establishment data is determined to not be malicious.

System Embodiment 1B. The system of System Embodiment 1, wherein the first processor further controls the malicious transaction detection device to perform the following operation: take at least one mitigation action or direct a communications device to take a mitigation action when the transaction corresponding to the received communications session establishment data is determined to be malicious.

System Embodiment 1C. The system of System Embodiment 1B, wherein the first processor further controls the malicious transaction detection device to perform the following operation: determine the mitigation action to be taken based on the probability determined that the transaction is malicious.

System Embodiment 1D. The system of System Embodiment 1B, wherein said take at least one mitigation action includes taking one or more of the following actions: i) completing the establishment of the communications session corresponding to the communications session establishment data to a destination party or a destination device (e.g., a user equipment device) identified (e.g., via a destination address, called party ID, called party number) in the communications session establishment data with an indication that the communications session is suspected of being malicious; ii) redirecting the communications session corresponding to the communications session establishment data to a validation service; iii) assigning the communications session corresponding to the communications session establishment data a lower incoming communications session (e.g., call) priority than a non-suspect malicious communications session when placing the communications session (e.g., call) in a communications session (e.g., call) handling queue (thereby resulting in suspect malicious communications sessions having a longer delay before being answered on average than non-suspect malicious communications sessions); iv) delivering the communications session (e.g., call) corresponding to the communications session establishment data to voice mail; or v) dropping or blocking the communications session (e.g., call) corresponding to the communications session establishment data.

System Embodiment 2. The system of System Embodiment 1, wherein the determination model is built, generated, created, or implemented using artificial intelligence machine learning.

System Embodiment 3. The system of System Embodiment 1, further comprising: a plurality of synthetic data generator neural networks; wherein the synthetic communications session data is generated by the plurality of synthetic data generator neural networks; and wherein one or more of the plurality of synthetic data generator neural networks is trained using proprietary and/or confidential customer data.

System Embodiment 3A. The system of System Embodiment 1, wherein the synthetic communications session data does not include actual customer data.

System Embodiment 3B. The system of System Embodiment 1, wherein the synthetic communications session data does not include any customer identifiable information.

System Embodiment 3C. The system of System Embodiment 3B, wherein the synthetic communications session data includes the characteristics and patterns of a plurality of different customers' actual proprietary, confidential and/or restricted customer data.

System Embodiment 4. The system of System Embodiment 2, wherein the synthetic communications session data is generated by a plurality of synthetic data generator neural networks; and wherein said one or more of the plurality of synthetic data generator neural networks is trained using actual proprietary or confidential customer data includes at least two synthetic data generator neural networks.

System Embodiment 5. The system of System Embodiment 3, wherein one or more of the plurality of synthetic data generator neural networks are built, created or generated using an adversarial training process; and wherein said adversarial training process is implemented at a customer's premises where said proprietary and/or confidential customer data is located and/or maintained.

System Embodiment 6. The system of System Embodiment 5, wherein the adversarial training process utilizes a Generative Adversarial Network.

System Embodiment 7. The system of System Embodiment 3, wherein at least one of the plurality of synthetic data generator neural networks is trained at a customer's premises; and wherein the proprietary and/or confidential customer data used to train the at least one of the plurality of synthetic data generator neural networks is maintained or located at the customer's premises.

System Embodiment 8. The system of System Embodiment 7, wherein each of the synthetic data generator neural networks after being trained is re-located to a cloud environment, said cloud environment not being controlled or secured by the customer or customers whose actual data was used in training the synthetic data generator neural network or synthetic data generator neural networks.

System Embodiment 9. The system of System Embodiment 3, wherein one or more of the synthetic data generator neural networks is a variational autoencoder neural network.

System Embodiment 10. The system of System Embodiment 1 further comprising: a plurality of synthetic data generator neural networks, said plurality of synthetic data generator neural networks each being trained using separate proprietary session transaction data sets obtained from customer session transaction records (e.g., CDRs); each of the plurality of synthetic data generator neural networks being operated to generate synthetic communications session data used for training the malicious transaction detection device.

System Embodiment 11. The system of System Embodiment 10, wherein the plurality of synthetic data generator neural networks includes a first synthetic data generator neural network, and wherein the first synthetic data generator is trained to generate first synthetic communications session data.

System Embodiment 12. The system of System Embodiment 11, wherein the first synthetic data generator neural network is an autoencoder neural network; and wherein the system further includes a first synthetic data generator neural network training device including a third processor that controls the first synthetic data generator neural network to train the first synthetic data generator neural network, said training the first synthetic data generator neural network including: generating, by a labeling classifier, a training set of labeled input feature vectors based on actual customer communications session data (e.g., proprietary call detail records); inputting a first portion of the training set of labeled input feature vectors into the first synthetic data generator neural network; inputting noise (e.g., Gaussian noise) into one or more internal nodes (e.g., nodes of the encoder, bottleneck or decoder layers) of the synthetic data generator neural network; outputting from the first synthetic data generator neural network a set of synthetic data feature vectors; combining the outputted set of synthetic data feature vectors with a second portion of the training set of labeled input feature vectors; inputting the combined outputted set of synthetic data feature vectors and second portion of the training set of labeled input feature vectors to a discriminator classifier; making a determination by the discriminator classifier as to whether each inputted feature vector is a synthetic data feature vector; adjusting the link weights of the first synthetic data generator neural network based on feedback from the discriminator classifier.

System Embodiment 13. The system of System Embodiment 12, wherein training the first synthetic neural network further includes: determining a classification error by the discriminator classifier as to whether the discriminator classifier incorrectly determined or classified an inputted feature vector as a synthetic data feature vector; adjusting link weights of the discriminator classifier to minimize the classification error; and wherein said adjusting the link weights of the first synthetic data generator neural network based on feedback from the discriminator classifier includes adjusting the link weights to maximize the classification error of the discriminator classifier.

System Embodiment 14. The system of System Embodiment 13, wherein training of the first synthetic data generator neural network continues until the classification error of the discriminator is above a first classification error threshold value.

System Embodiment 14A. The system of System Embodiment 13, wherein training of the first synthetic data generator neural network continues until the classification accuracy of the discriminator is below a first classification accuracy threshold value.

System Embodiment 15. The system of System Embodiment 14, wherein the first classification error threshold value is 0.4 indicating that the discriminator classifier properly determines the classification of an input feature vector 60% of the time.

System Embodiment 15A. The system of System Embodiment 14, wherein the first classification error threshold value is 0.5 indicating that the discriminator classifier properly determines the classification of an input feature vector 50% of the time.

System Embodiment 15B. The system of System Embodiment 14A, wherein the first classification accuracy threshold value is 0.6 indicating that the discriminator classifier properly determines the classification of an input feature vector 60% of the time.

System Embodiment 16. A system comprising: a set of N synthetic data generator neural networks trained using N sets of actual customer data, each synthetic data generator neural network being trained using a different set of the N sets of actual customer data, one or more of the N sets of actual customer data including proprietary information, N being a positive integer number greater than 1; and wherein each synthetic data generator neural network upon completing its training is able to generate a synthetic data set of labeled (e.g., good and bad) data samples representative of an environment in which the synthetic data generator neural network is trained, the generated synthetic data set not including any of the proprietary information of the training data set.

System Embodiment 17. The system of System Embodiment 16, wherein each of the synthetic data generator neural networks, which is trained using actual customer data including proprietary information, is trained in a controlled environment (e.g., at a secure location, e.g., customer premises, where the actual customer data is stored or maintained); and wherein synthetic data generated by each of the synthetic data generator neural networks, which is trained using actual customer data including proprietary information, includes data samples which are representative of the controlled environment in which the synthetic data generator was trained.

System Embodiment 18. The system of System Embodiment 17 further comprising: a classifier model trained using combined sets of labeled generated synthetic data samples (e.g., calls), said combined set of labeled generated synthetic data samples being generated by the set of N synthetic data generator neural networks, wherein each of the N synthetic data generator neural networks generates a set of labeled (e.g., good or bad) synthetic data samples (e.g., data samples being calls).

System Embodiment 19. The system of System Embodiment 16 further comprising: a classifier model built using a plurality of the trained N synthetic data generator neural networks.

System Embodiment 20. The system of System Embodiment 16, wherein proprietary information is information from which the customer or a user can be identified.

List of Exemplary Numbered Non-Transitory Computer Readable Medium Embodiments:

Non-Transitory Computer Readable Medium Embodiment 1. A non-transitory computer readable medium including a first set of computer executable instructions which when executed by a processor of a malicious transaction detection system cause the malicious transaction detection system to perform the steps of: receive communications session establishment data (e.g., session setup information such as for example source address information, destination address information, routing information, calling party identification information, called party identification information, etc.); determine a probability of whether the communications session establishment data indicates that the communications session is malicious (e.g., fraudulent, destructive, robocall and/or nuisance transaction); and when the determined probability is greater than or equal to a predetermined threshold value determine that a transaction corresponding to the received communications session establishment data is malicious; and when the determined probability is less than the predetermined threshold value determine that the transaction corresponding to the received communications session establishment data is not malicious; and wherein the malicious transaction detection system includes a determination model (e.g., classifier model) trained using synthetic communications session data.

Non-Transitory Computer Readable Medium Embodiment 2. The non-transitory computer readable medium of Non-Transitory Computer Readable Medium Embodiment 1, wherein the determination model is built, generated, created, or implemented using artificial intelligence machine learning.

Non-Transitory Computer Readable Medium Embodiment 3. The non-transitory computer readable medium of Non-Transitory Computer Readable Medium Embodiment 1, wherein the synthetic communications session data is generated by a plurality of synthetic data generator neural networks; and wherein one or more of the plurality of synthetic data generator neural networks is trained using proprietary and/or confidential customer data.

Non-Transitory Computer Readable Medium Embodiment 4. A non-transitory computer readable medium including a first set of computer executable instructions which when executed by a processor of an synthetic data generator device cause the synthetic data generator device to perform the steps of: training a set of N synthetic data generator neural networks using N sets of actual customer data, each synthetic data generator neural network being trained using a different set of the N sets of actual customer data, one or more of the N sets of actual customer data including proprietary information, N being a positive integer number greater than 1; and upon completing the training of the N synthetic data generator neural networks, each synthetic data generator neural network is able to generate a synthetic data set of labeled (e.g., good and bad) data samples representative of an environment in which the synthetic data generator neural network is trained, the generated synthetic data set not including any of the proprietary information of the training data set.

While various embodiments have been discussed above and in the claims below, it should be appreciated that not necessarily all embodiments include the same features and some of the features described herein are not necessary but can be desirable in some embodiments. Numerous additional features, embodiments and benefits of various embodiments are discussed in the claims which follow.

The techniques of various embodiments may be implemented using software, hardware and/or a combination of software and hardware. Various embodiments are directed to apparatus, e.g., neural networks, classifiers, detection systems/devices, database systems, call processing devices, communications devices, network nodes and/or network equipment devices. Various embodiments are also directed to methods, e.g., method of controlling and/or operating devices such as neural networks, classifiers, detection systems/devices, database systems, call processing devices, communications devices, network nodes and/or network equipment devices. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps or elements of the described methods.

In various embodiments each of the steps or elements of a method are implemented using one or more processors. In some embodiments, each of the steps or elements are implemented using hardware circuitry.

In various embodiments nodes and/or elements described herein are implemented using one or more components to perform the steps corresponding to one or more methods, for example, message reception, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., sensors, call processing devices, gateways, session border, network nodes and/or network equipment devices, including a processor configured to implement one, multiple or all of the steps of one or more methods of the invention.

In some embodiments, the processor or processors, e.g., CPUs, of one or more devices, e.g., computing nodes such as neural networks, detection systems/devices, database systems, call processing devices, communications devices, network nodes and/or network equipment devices are configured to perform the steps of the methods described as being performed by the computing nodes, e.g., neural networks, classifiers, detection systems/devices systems/devices, database systems, call processing devices, communications devices, network nodes and/or network equipment devices. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., computing node such as neural networks, classifiers, detection systems/devices, database systems, call processing devices, communications devices, network nodes and/or network equipment devices with a processor which includes a component corresponding to each of the steps of the various described methods performed by the device in which the processor is included. In some, but not all, embodiments a device, e.g., computing node such as neural networks, classifiers, detection systems/devices, database systems, call processing devices, communications devices, network nodes and/or network equipment devices, includes a component corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a computing device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a neural network, classifiers, detection systems/devices, database systems, call processing devices, communications devices, network nodes and/or network equipment devices described in the present application.

Numerous additional variations on the methods and apparatus of the various embodiments described above will be apparent to those skilled in the art in view of the above description. Numerous additional embodiments, within the scope of the present invention, will be apparent to those of ordinary skill in the art in view of the above description and the claims which follow. Such variations and embodiments are to be considered within the scope of the invention.

What is claimed is:

1. A method for detecting malicious transactions comprising:
operating a malicious transaction detection system to receive communications session establishment data;
operating the malicious transaction detection system to determine a probability of whether the communications session establishment data indicates that the communications session is malicious; and
when the determined probability is greater than or equal to a predetermined threshold value determining that a transaction corresponding to the received communications session establishment data is malicious; and
when the determined probability is less than the predetermined threshold value determining that the transaction corresponding to the received communications session establishment data is not malicious; and
wherein the malicious transaction detection system includes a determination model trained using synthetic communications session data.

2. The method of claim 1, wherein the determination model is built, generated, or created using artificial intelligence machine learning.

3. The method of claim 1,
wherein the synthetic communications session data is generated by a plurality of synthetic data generator neural networks;
wherein one or more of the plurality of synthetic data generator neural networks is trained using proprietary or confidential customer data.

4. The method of claim 3,
wherein the synthetic communications session data is generated by a plurality of synthetic data generator neural networks; and
wherein said one or more of the plurality of synthetic data generator neural networks is trained using actual proprietary or confidential customer data includes at least two synthetic data generator neural networks.

5. The method of claim 3,
wherein one or more of the plurality of synthetic data generator neural networks are built, created or generated using an adversarial training process;
wherein said adversarial training process is implemented at a customer's premises where said proprietary or confidential customer data is located or maintained.

6. The method of claim 5,
wherein the adversarial training process utilizes a Generative Adversarial Network.

7. The method of claim 4,
wherein one or more of the plurality of synthetic data generator neural networks is trained at a customer's premises using proprietary or confidential customer data maintained or located at the customer's premises.

8. The method of claim 7, wherein each of the synthetic data generator neural networks after being trained are re-located to a cloud environment, said cloud environment not being controlled or secured by the customer or customers on whose actual data the synthetic data generator neural network was trained.

9. The method of claim 3, wherein one or more of the synthetic data generator neural networks is a variational autoencoder neural network.

10. The method of claim 1 further comprising:
generating said synthetic communications session data used for training the malicious transaction detection system using a plurality of synthetic data generator neural networks, said plurality of synthetic data generator neural networks each being trained using separate proprietary session transaction data sets obtained from customer session transaction records.

11. The method of claim 10 further comprising:
prior to generating said synthetic communications session data, training a first synthetic data generator neural network to generate synthetic communications session data, said first synthetic data generator neural network being one of said plurality of synthetic data generator neural networks.

12. The method of claim 11,
wherein the first synthetic data generator neural network is an autoencoder neural network:
wherein said training the first synthetic data generator neural network includes:
generating, by a labeling classifier, a training set of labeled input feature vectors based on actual customer communications session data;
inputting a first portion of the training set of labeled input feature vectors into the first synthetic data generator neural network;
inputting noise into one or more internal nodes of the synthetic data generator neural network;
outputting from the first synthetic data generator neural network a set of synthetic data feature vectors;
combining the outputted set of synthetic data feature vectors with a second portion of the training set of labeled input feature vectors;
inputting the combined outputted set of synthetic data feature vectors and second portion of the training set of labeled input feature vectors to a discriminator classifier;
making a determination by the discriminator classifier as to whether each inputted feature vector is a synthetic data feature vector;
adjusting the link weights of the first synthetic data generator neural network based on feedback from the discriminator classifier.

13. A system comprising:
a malicious transaction detection device including:
memory; and
a first processor, the first processor controlling the malicious transaction detection device to perform the following operations:
receive communications session establishment data;
determine a probability of whether the communications session establishment data indicates that the communications session is malicious; and
when the determined probability is greater than or equal to a predetermined threshold value determining that a transaction corresponding to the received communications session establishment data is malicious; and
when the determined probability is less than the predetermined threshold value determining that the transaction corresponding to the received communications session establishment data is not malicious; and
wherein the malicious transaction detection device further includes a determination model trained using synthetic communications session data to classify communications session establishment data as good or bad.

14. The system of claim 13, wherein the determination model is built, generated, created, or implemented using artificial intelligence machine learning.

15. The system of claim 13, further comprising:
a plurality of synthetic data generator neural networks;
wherein the synthetic communications session data is generated by the plurality of synthetic data generator neural networks; and
wherein one or more of the plurality of synthetic data generator neural networks is trained using proprietary or confidential customer data.

16. The system of claim 15,
wherein one or more of the plurality of synthetic data generator neural networks are built, created or generated using an adversarial training process; and
wherein said adversarial training process is implemented at a customer's premises where said proprietary or confidential customer data is located or maintained.

17. The system of claim 16, wherein the adversarial training process utilizes a Generative Adversarial Network.

18. The system of claim 15,
wherein at least one of the plurality of synthetic data generator neural networks is trained at a customer's premises; and
wherein the proprietary or confidential customer data used to train the at least one of the plurality of synthetic data generator neural networks is maintained or located at the customer's premises.

19. The system of claim 13 further comprising:
a plurality of synthetic data generator neural networks, said plurality of synthetic data generator neural networks each being trained using separate proprietary session transaction data sets obtained from customer session transaction records; and
each of the plurality of synthetic data generator neural networks being operated to generate synthetic communications session data used for training the malicious transaction detection device.

20. A non-transitory computer readable medium including a first set of computer executable instructions which when executed by a processor of a malicious transaction detection system cause the malicious transaction detection system to perform the steps of:
receive communications session establishment data;
determine a probability of whether the communications session establishment data indicates that the communications session is malicious; and
when the determined probability is greater than or equal to a predetermined threshold value, determine that a transaction corresponding to the received communications session establishment data is malicious; and
when the determined probability is less than the predetermined threshold value, determine that the transaction corresponding to the received communications session establishment data is not malicious; and
wherein the malicious transaction detection system includes a determination model trained using synthetic communications session data.
